(19) United States
(12) Patent Application Publication
(10) Pub. No.: US 2022/0346397 A1
(43) Pub. Date: Nov. 3, 2022

(54) DAIRY PRODUCT AND PROCESS

(71) Applicant: FONTERRA CO-OPERATIVE GROUP LIMITED, Auckland City (NZ)

(72) Inventor: Skelte Gerald ANEMA, Auckland (NZ)

(21) Appl. No.: 17/596,654

(22) PCT Filed: Jun. 19, 2020
(86) PCT No.: PCT/IB2020/055759

§ 371 Date: Dec. 15, 2021

(30) Foreign Application Priority Data
Jun. 19, 2019 (NZ) 754700

(51) Int. Cl. A23C 9/13; A23C 13/14; A23C 9/154; A23C 9/156

(52) U.S. Cl. CPC A23C 9/1315; A23C 9/1307; A23C 13/14; A23C 9/1544; A23C 9/156

(57) ABSTRACT

A cream composition comprising lipid, optionally protein, one or more emulsifiers, and one or more thickeners or stabilisers, minerals and optionally lactose having acceptable properties after temperature cycling, including acceptable viscosity, and sensory properties.

### FIELD OF THE INVENTION

The present invention relates to creams, in particular dairy and non-dairy creams, coffee creams, half and half, fermented creams, sour or acidic creams, light creams, whipping creams, heavy creams, creamers, dry cream, and cream analogues, etc. and to methods of manufacturing such creams and cream products. The invention particularly relates to the manufacture of creams and cream products that preserve the original natural cream colour, maintain the natural flavour and mouthfeel characteristics, and enhance shelf stability when processed at ultra-high temperatures (UHT). Additionally, UHT creams of the invention resist destabilisation when exposed to temperature fluctuations, thereby retaining flavour, colour, and functionality.

### BACKGROUND TO THE INVENTION

Dairy creams are enriched fat products produced from milk that may contain other allowed dairy and/or permitted non-dairy ingredients, such as emulsifiers and stabilisers. Such creams may be produced by separating milk to produce a cream base. The cream base is then further processed by the addition of suitable dairy and other allowed ingredients. Alternatively, creams may be manufactured by blending various concentrated milk fat ingredients with liquid or dry milk ingredients and water to produce recombined cream products. Recombined cream and/or recombined whipping creams are processed with high shear to adequately emulsify the milk fat with the available proteins and/or with added emulsifiers. Cream analogues, non-dairy creams, and dairy cream alternatives also may be produced with alternative fat and/or protein sources, such as suitable plant-based fats, milk proteins, other suitable proteins, water, and/or other optionally allowed ingredients, including emulsifiers and stabilisers.

Numerous creams are made with differing fat contents to simultaneously meet relevant legal regulations and customer functionality expectations. The CODEX Standard for Cream and Prepared Creams (CODEX STAN 288-1976) specifies a minimum fat content of 10% (w/w) for cream [part 3.3 Composition]. Similarly, the US Standards of Identity Title 21 Food and Drugs specify that “cream” must contain 18% milk fat [§ 131.3(a)], Heavy Whipping cream must contain 36% milk fat [§ 131.150], Light cream must contain 18% but 30% milk fat [§ 131.155], and Light whipping cream must contain 30% but 36% milk fat [§ 131.157]. Whipping creams usually contain 30% milk fat to enhance whipping ability and functionality.

Creams routinely are pasteurised using heat treatments that kill pathogenic microorganisms. However, standard pasteurisation heat treatments do not destroy heat resistant spoilage microorganisms present in creams. Therefore, pasteurised creams still require refrigeration to provide an acceptable shelf-life by inhibiting microbial spoilage.

Alternatively, UHT heat treatments, such as 140° C. for 2 s, essentially kill all microorganisms present in creams, which greatly enhances the shelf-life of cream at refrigeration temperatures. However, such heat treatments promote Maillard browning. Maillard browning changes the white colour of cream to various shades of tan-to-brown and produces a distinctive cooked, caramelised flavour. The severity of the UHT heat treatment proportionally enhances the extent of colour and flavour changes. Although the UHT heat treatment prevents microbial spoilage, exposing UHT creams to fluctuating temperatures also promotes undesirable physical changes including phase separation, thickening, and/or solidification. Therefore, UHT creams still require continuous refrigeration to remain palatable and functional.

Unfortunately, many markets cannot provide continuous refrigeration during storage, transportation, and/or display. The UHT creams in these markets frequently are exposed to temperatures 30° C. before re-establishing refrigerated storage. Such temperature fluctuations frequently cause UHT creams and whipping creams to solidify, which creates difficulties in pouring, increases whipping time, reduces overrun, and decreases the ability to retain desired whipped shapes such as rosettes (Hoffmann, 1999, Storage stability of UHT whipping cream, Kieler Milchwirtschaftliche Forschungsberichte 51(2), 125-136). Finally, the low pH, 4.6, of sour or acidic creams promotes casein coagulation during UHT heating to produce casein curd, or thickening, releases free whey, and ruins sour or acidic cream functionality.

It is an object of the invention to provide improved or alternative cream products.

Other objects of the invention may become apparent from the following descriptions which are given by way of example only. Reference to external sources of information in this specification include patent specifications and other documents to generally provide a context for discussing the features of the present invention. Unless stated otherwise, reference to such sources of information is not to be construed, in any jurisdiction, as an admission that such information constitutes prior art describing the creams and manufacturing methods of the invention.

### SUMMARY OF THE INVENTION

Accordingly, the invention broadly comprises a cream composition comprising lipid, optionally protein, one or more emulsifiers, one or more thickeners or stabilisers, minerals and optionally lactose. The compositions minimise browning during UHT treatment, retain natural cream colour, preserve the natural cream flavour and mouthfeel characteristics (creaminess, mouth-coating, smoothness), maintain functionality such as whipping and resist destabilisation when exposed to temperature fluctuations.

In one aspect, the invention provides a cream composition comprising:
a) about 7.5 to about 65% by weight lipid;
b) about 0% to about 2%, preferably about 0.5% to about 1.2% by weight protein per litre of cream plasma;
c) about 0.01% to about 1.0% by weight of one or more emulsifiers;
d) about 0.05% to about 3%, preferably about 0.05% to about 0.3% by weight of one or more thickeners or stabilisers;
e) about 30 mM to about 120 mM total cations per litre of cream plasma; and
f) about 25 mM to about 120 mM total anions per litre of cream plasma.

In another aspect, the invention provides a cream composition comprising:
a) about 7.5 to 65% by weight lipid;
b) about 0% to about 2%, preferably about 0.5% to about 1.2% by weight protein per litre of cream plasma;
c) about 0.01% to about 1.0% by weight of one or more emulsifiers;
d) about 0.05% to about 3%, preferably about 0.05% to about 0.3% by weight of one or more thickeners or stabilisers;
e) about 5 to about 60 mM total divalent cations per litre of cream plasma;
f) about 25 to about 60 mM total monovalent cations per litre of cream plasma; and
g) about 25 to about 120 mM total anions per litre of cream plasma, including about 5 to about 15 mM citrate per litre of cream plasma.

In a further aspect, the invention provides a method of preparing a cream composition of the invention, the method comprising
a) separating a first dairy liquid to obtain a cream base;
b) optionally blending a lipid source such as a high fat dairy liquid into the cream base to form a lipid enriched dairy liquid;
c) blending allowed dairy or non-dairy ingredients including minerals, one or more emulsifiers and one or more thickeners or stabilisers into the cream base or the lipid enriched dairy liquid;
d) homogenising the cream base or the lipid enriched dairy liquid to form a homogenised dairy liquid including the added allowed dairy or non-dairy ingredients; and
e) heating the homogenised dairy liquid including the added allowed dairy or non-dairy ingredients to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; v) about 30 mM to about 120 mM total cations per litre of cream plasma; and vi) about 25 mM to about 120 mM total anions per litre of cream plasma.

In some embodiments, the method comprises a pasteurisation step at any stage of the process. For example, the first dairy liquid, cream base, lipid enriched dairy liquid, cream base or lipid enriched dairy liquid including the added allowed dairy or non-dairy ingredients, homogenised dairy liquid, or the cream composition may be pasteurised. Preferably, the method comprises pasteurising i) the first dairy liquid prior to step a), or ii) the lipid enriched dairy liquid prior to step c).

In some embodiments, the method comprises an additional step of adjusting the pH of the cream base or lipid enriched dairy liquid prior to step d).

In a further aspect, the invention provides a method of preparing a cream composition of the invention, the method comprising:
a) providing a dairy liquid permeate or a simulated milk ultrafiltrate as a dairy liquid base;
b) blending allowed dairy or non-dairy ingredients including one or more emulsifiers and one or more thickeners or stabilisers into the dairy liquid base;
c) blending a lipid source such as a high fat dairy liquid into the dairy liquid base including the added dairy or non-dairy ingredients to form a lipid enriched dairy liquid;
d) homogenising the lipid enriched dairy liquid to form a homogenised lipid enriched dairy liquid;
e) heating the homogenised lipid enriched dairy liquid to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; and v) about 30 mM to about 120 mM total cations per litre of cream plasma; and vi) about 25 mM to about 120 mM total anions per litre of cream plasma.

In some embodiments, the method comprises a pasteurisation step at any stage of the process. For example, the dairy liquid base, dairy liquid base including the added allowed dairy or non-dairy ingredients, lipid enriched dairy liquid, homogenised lipid enriched dairy liquid, or the cream composition may be pasteurised. Preferably, the method comprises pasteurising the lipid enriched dairy liquid prior to step d).

In some embodiments, the method comprises an additional step of adjusting the pH of the lipid enriched dairy liquid prior to step d).

The following embodiments may relate to any of the above aspects in any combination.

In various embodiments the cream composition may be a coffee cream, whipping cream, half and half, fermented cream, light cream, whipping cream, heavy cream, dry cream, recombined cream, recombined whipping cream, creamer, sour or acidified cream. Preferably, the cream is a UHT cream, for example a UHT whipping cream.

In various embodiments the composition may comprise about 10% or above by weight lipid, for example about 25% to about 40% by weight lipid. Preferably, the lipid comprising one or more mammalian milk lipids, more preferably one or more bovine milk lipids, selected from the group consisting of cream, high fat cream, reconstituted cream powder, anhydrous milk fat (AMF), ghee, butter, β-serum powder, whole milk powder (WMP), high fat milk protein concentrate, or any combination of any two or more thereof. Alternatively, or additionally, the lipid comprises one or more refined and/or hydrogenated vegetable fat sources selected from the group consisting of palm, palm kernel, coconut, soybean, rapeseed, cottonseed, sunflower seed, corn, safflower seed, rice bran oil, sesame oil, olive oil, fractions thereof, or any combination of any two or more thereof. In various embodiments the composition may comprise any two or more, or any three or more, or any four or more of these lipid components. Preferably the lipid comprises cream, high fat cream, reconstituted cream powder, anhydrous milk fat (AMF), or any combination of any two or more thereof.

In various embodiments the composition may comprise about 10, 18, 25, 27, 30, 33, 35, 36, or 40% by weight lipid, and useful ranges may be selected between any of these values (for example, from about 25 to about 40, about 25 to about 35, about 25 to about 30, about 27 to about 40, about 30 to about 40, about 33 to about 40, about 35 to about 40, or about 37 to about 40% by weight).

In various embodiments the composition may comprise from about 10 to about 18% by weight lipid (i.e., Half and Half). In other embodiments the composition may comprise about 18% or above by weight lipid. In various embodiments the composition may comprise from about 18 to about 30% by weight lipid (i.e., FDA Light Cream). In various embodiments the composition may comprise from about 30 to about 36% by weight lipid (i.e., FDA Light Whipping Cream). In other embodiments the composition may comprise about 36% or above by weight lipid (i.e., FDA Heavy Whipping Cream).

In various embodiments the composition may comprise about 0% to about 2% by weight protein per litre of cream plasma. Suitable protein sources are known to the skilled person and include dairy, egg, plant, and food grade microbial and algal proteins. Preferably, the composition comprises one or more mammalian milk proteins, more preferably one or more bovine milk proteins, wherein the protein comprises or comprises a source of protein selected from the group consisting of milk, skim milk, cream, whole milk, acid whey, sweet whey, whole milk powder (WMP), skim milk powder (SMP), buttermilk powder (BMP), acid whey powder, sweet whey powder, caseinate, sodium caseinate, calcium caseinate, whey protein concentrate (WPC), whey protein isolate (WPI), milk protein isolate (MPI), milk protein concentrate (MPC), modified MPC derivatives, and micellar casein. Alternatively, or additionally, the protein comprises one or more non-dairy sources selected from plant or animal sources such as soy, egg and/or pea protein, or any combination of any two or more thereof. In various embodiments the composition may comprise any two or more, or any three or more, or any four or more of these components. Preferably the protein comprises milk, skim milk, cream, whole milk, whole milk powder (WMP), skim milk powder (SMP), buttermilk powder (BMP), caseinate, sodium caseinate, calcium caseinate, whey protein concentrate (WPC), whey protein isolate (WPI), milk protein isolate (MPI), milk protein concentrate (MPC), modified MPC derivatives, micellar casein, or any combination of any two or more thereof.

In various embodiments the composition may comprise about 0, 0.25, 0.5, 0.75, 1, 1.25, 1.5, 1.75, or 2% by weight protein per litre of cream plasma, and useful ranges may be selected between any of these values (for example, from about 0 to about 1.5, about 0.5 to about 1.5, about 1 to about 2, about 0 to about 0.5% by weight protein per litre of cream plasma. Preferably, the composition comprises about 0 to about 1.2%, more preferably from about 0 to about 0.5%, for example from 0 to about 0.25% or from 0.25 to about 0.5% by weight protein per litre of cream plasma.

In various embodiments the composition may comprise about 0.01% to about 1.0% by weight of one or more emulsifiers selected from the group consisting of protein, phospholipids, including phospholipids from milkfat globule membrane, buttermilk powder, β-serum powder (the dried aqueous phase removed from pasteurised dairy cream during the manufacture of AMF), or an emulsifier listed in Codex Standard 288-1976 for creams such as lecithin, mono and diglycerides, distilled monoglycerides, acid esters of mono-diglycerides including lactic, citric, acetic, diacetyltartaric and tartaric, polysorbates (Tweens), sorbitan esters of fatty acids (SPANS), sucrose esters, polyglycerol esters of fatty acids, propylene glycol esters of fatty acids, sodium or calcium stearoyl lactylate, or any combination of any two or more thereof. In various embodiments the composition may comprise any two or more, or any three or more, or any four or more of these components. Preferably the one or more emulsifiers are selected from the group consisting of protein, phospholipids from milkfat globule membrane, buttermilk powder, β-serum powder, lecithin, mono and diglycerides, distilled monoglycerides, acid esters of mono-diglycerides including lactic, citric, acetic, diacetyltartaric and tartaric, polysorbates, sorbitan esters of fatty acids, sucrose esters, polyglycerol esters of fatty acids, propylene glycol esters of fatty acids, sodium or calcium stearoyl lactylate, or any combination of any two or more thereof. More preferably the one or more emulsifiers comprise two or more of lecithin, mono and diglycerides, polysorbates, sucrose esters, and propylene glycol esters of fatty acids.

In various embodiments the composition may comprise about 0.01, 0.025, 0.05, 0.075, 0.1, 0.2, 0.3, 0.4, 0.5, 0.6, 0.7, 0.8, 0.9, or 1.0% by weight of one or more emulsifiers, and useful ranges may be selected between any of these values (for example, from about 0.01 to about 1.0, about 0.025 to about 1.0, about 0.05 to about 1.0, about 0.075 to about 1.0, about 0.1 to about 1.0, about 0.2 to about 1.0, about 0.4 to about 1.0, about 0.5 to about 1.0, or about 0.6 to about 1.0% by weight).

In various embodiments the composition may comprise about 0.05% to about 3%, preferably to about 0.3%, or about 0.05% to about 3% by weight of one or more thickeners or stabilisers selected from the group consisting of, for example, carrageenan, guar gum, locust bean gum, Tara gum, gellan gum, xanthan gum, acacia gum, microcrystalline cellulose (MCC), carboxymethyl cellulose (CMC), cellulose derivatives, propylene glycol alginate, sodium alginate, pectin, gelatin, starch, starch derivatives, citrus fibre, or any combination of any two or more thereof. In various embodiments the composition may comprise any two or more, or any three or more, or any four or more of these components. Preferably the one or more thickeners or stabilisers are selected from the group consisting of carrageenan, guar gum, locust bean gum, Tara gum, gellan gum, xanthan gum, acacia gum, microcrystalline cellulose (MCC), carboxymethyl cellulose (CMC), cellulose derivatives, propylene glycol alginate, sodium alginate, pectin, gelatin, starch or starch derivatives, or citrus fibre, or any combination of any two or more thereof. More preferably the one or more thickeners or stabilisers comprise xanthan, carrageenan, and guar gum.

In various embodiments the composition may comprise about 0.05, 0.075, 0.1, 0.15, 0.2, 0.25, 0.3, 0.4, 0.5, 0.6, 0.7, 0.8, 0.9, 1, 1.5, 2, 2.5, or 3% by weight of one or more thickeners or stabilisers, and useful ranges may be selected between any of these values (for example, from about 0.05 to about 5, about 0.05 to about 4, about 0.05 to about 3, about 0.05 to about 2, about 0.05 to about 1, about 0.05 to about 0.9, about 0.05 to about 0.8, about 0.05 to about 0.7, about 0.05 to about 0.6, about 0.05 to about 0.5, about 0.05 to about 0.4, or about 0.05 to about 0.3% by weight).

In various embodiments the monovalent cations in the composition comprise sodium and potassium. Preferably, the composition may comprise 25, 30, 40, 50, or 60 mM of monovalent cations per litre of cream plasma, and useful ranges may be selected between any of these values (for example, from about 40 to about 60 mM, about 45 to about 55 mM, or about 47.5 to about 52.5 mM of monovalent cations per litre of cream plasma).

In various embodiments the divalent cations in the composition comprise calcium and magnesium. Preferably, the composition may comprise 5, 8, 10, 15, 20, 30, 40, 50, or 60 mM of divalent cations per litre of cream plasma, and useful ranges may be selected between any of these values (for example, from about 8 to about 20 mM, about 9 to about 15 mM or about 10.5 to about 12.5 mM of divalent cations per litre of cream plasma). In various embodiments, for example when acid whey or acid permeate are used as the dairy liquid base, useful ranges of divalent cations may be higher, for example from about 25 to about 60 mM, about 35 to about 50 mM or about 40 to about 45 mM of divalent cations per litre of cream plasma.

In various embodiments the total cations in the composition include the sum of sodium, potassium, calcium and magnesium. Preferably, the composition may comprise 30, 40, 45, 50, 60, 70, 80, 90, 100, 110 or 120 mM of total cations per litre of cream plasma, and useful ranges may be selected between any of these values (for example, from about 45 to about 110 mM, about 48 to about 65, about 50 to about 100, about 55 to about 95, about 60 to about 85, or about 75 to about 85 mM of total cations per litre of cream plasma.

In various embodiments the total anions in the composition include the sum of phosphate, chloride and citrate. Preferably, the composition may comprise 25, 30, 35, 40, 50, 60, 70, 80, 90, 100 or 120 mM of total anions per litre of cream plasma, and useful ranges may be selected between any of these values (for example, from about 25 to about 90 mM, about 30 to about 80, about 35 to about 75, or about 50 to about 65 mM of total anions per litre of cream plasma.

In various embodiments the composition may comprise 5, 7, 9, 11, 13 or 15 mM of citrate per litre of cream plasma, and useful ranges may be selected between any of these values (for example, from about 6.5 to about 13 mM, about 7 to about 11 mM, about 7 to about 9 mM, or about 7.5 to about 8.5 mM of citrate per litre of cream plasma.

Suitable sources for the identified cations, anions, and citrate may include dairy and non-dairy sources. Dairy sources may include permeate produced by membrane filtration of milk or whey. Membrane filtration includes microfiltration (MF), ultrafiltration (UF), and nanofiltration (NF). Permeate may receive further membrane filtration, ion exchange, and/or electrodialysis processing to fractionate or concentrate the protein, carbohydrate, cations, anions, and/or citrate. Suitable fraction technologies include nanofiltration and ion exchange. The permeate and/or permeate fractions may be further concentrated and/or dried, for example the dairy source may be permeate powder. Dried or powdered permeate may be reconstituted before use. Lactose may also be removed from permeate to provide another suitable source of cations and anions, such as phosphate, chloride and citrate. Suitable non-dairy mineral sources may include prepared simulated milk ultrafiltrate (SMUF) preparations, as described by Jenness and Koops (1962. Preparation and properties of a salt solution which simulates milk ultrafiltrate. Netherlands Milk and Dairy J. 16:153-164)

In certain embodiments, the composition may further comprise one or more natural or artificial sweeteners. The sweeteners that may be used in the creams of the present invention include one or more sugars, such as lactose, hydrolysed lactose, fructose, sucrose, galactose, dextrose and/or syrup. Other sweetening carbohydrates and sugar alcohol or combinations with artificial sweeteners may also be used. For example, sugar alcohols, such as xylitol, sorbitol, lactitol, maltitol and isomalt. In various embodiments the composition may comprise about 0.001 to about 6% by weight, preferably about 0.05 to about 5%, for example about 1 to about 4.5%, about 1.5 to about 4.5%, about 2 to about 4%, about 3 to about 4%, or about 3.5 to about 4% by weight sweetener.

In various embodiments, the composition further comprises sweetener at a concentration of 0.3% to 0.9% of Sucrose Equivalent Sweetness. As used herein, 1% (or other given amount) of Sucrose Equivalent Sweetness (“SES”) means the amount of sweetener needed to be added to an 250 ml glass of water in order to provide the same sweetness as an independent 250 ml glass of water containing 1% (or the other given amount) of sucrose. For example, 6.67% of lactose will equal about 1% of SES because lactose is about 6.67 times less sweet than sucrose. Similarly, 0.005% of aspartame will equal about 1% of SES because aspartame is about 200 times sweeter than sucrose.

Preferably, the sweetener is lactose. In various embodiments, the composition may comprise about 2% to about 6% by weight, preferably about 3 to 5%, for example about 3.5 to about 4.5%, about 3 to about 4%, or about 3.5 to about 4% by weight lactose.

In other embodiments, the sweetener is fructose. Typically, 0.58% of fructose will equal about 1% of SES because fructose is 1.73 times sweeter than sucrose. In various embodiments, the composition may comprise about 0.17% to about 0.52% by weight fructose. In other embodiments, the sweetener is sorbitol, where 1.67% of sorbitol will equal about 1% of SES because sorbitol is 1.67 times less sweet than sucrose. In various embodiments, the composition may comprise about 0.5% to about 1.5% by weight sorbitol.

In certain embodiments, the composition may further comprise a buffering or chelating salt, preferably about 0 to about 0.03% by weight, for example about 0.01 to about 0.025% by weight of the buffering or chelating salt. Buffering or chelating salts can be selected from but not limited to, orthophosphates, polyphosphates and citrates, or any combination of any two or more thereof. For example, in certain exemplary embodiments the buffering or chelating salt is a polyphosphate salt, such as sodium or potassium polyphosphate.

In various embodiments the composition may exhibit an overrun of at least about 80%, for example at least 85, 90, 95, 100, 110, 120, 130, 140, 150, 160, 170, 180, 190, 200, 210, 220, 230 or 240% when whipped at 4 to 10° C. using a bowl and whisk, and useful ranges may be selected between any of these values (for example, from about 90 to about 240, about 100 to about 240, about 120 to about 240, about 140 to about 240, about 160 to about 240, about 160 to about 220, about 180 to about 220, or about 200 to about 220%). In some embodiments, the composition maintains an overrun following whipping of greater than about 150%, for example greater than about 160%, greater than about 170%, greater than about 180%, greater than about 190%, greater than about 200% or greater than about 220%.

In various embodiments the composition may exhibit improved gas canister performance compared to standard creams. In various embodiments, the number of shakes of a standard gas canister containing the composition required to achieve a first good rosette is less than about 20, for example 5, 10, or 15 shakes, and useful ranges may be selected between any of these values (for example 5 to 10 shakes). Preferably, the number of shakes required to achieve a first good rosette is about 10 or less for the first rosette, and in increments of about 5 thereafter.

In various embodiments the composition may produce about 45, about 50, about 55 or about 60 rosettes of acceptable quality (i.e., firm with acceptable edge definition and little or no loss of definition after 15 minutes at ambient temperature) per kilogram of liquid cream, and useful ranges may be selected between any of these values (for example, about 50 to about 60 rosettes per kilogram of liquid cream). In various embodiments, when rosettes or acceptable quality can no longer be produced from the canister, the amount of cream remaining in the canister is less than about 15% of the initial liquid cream volume, preferably less than 10%, more preferably less than 6% of the initial liquid cream volume.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after holding at 25° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after two, or three or more cycles of holding at 25° C. or 30° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in apparent viscosity of less than about 50, 55, 60, 65, 70, 75, 80, 85, 90, 95, or 100% measured at a shear rate of 1 s⁻¹ at 5° C. after one, two, or three or more cycles of holding at 30° C. for 24 hours followed by holding at 10° C. for 24 hours, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit a change in storage modulus, G′, of less than about 50, 55, 60, 65, 70, 75, 80, 85, 90, 95, or 100% measured using small strain rheology, using a strain of 0.05% and a frequency of oscillation of 0.1 Hz at 5° C. after one, two, or three or more cycles of holding at 25° C. or 30° C. (or 32.5° C.) for 15 minutes, for example using the method described herein in Example 2, and useful ranges may be selected between any of these values (for example, about 50 to about 100, about 50 to about 90, about 50 to about 80, or about 60 to about 100%). Preferably the change is less than about 100% or less than about 50%.

In various embodiments the composition may exhibit acceptable pourability, where the composition pours from the pack without sticking, or lumping after one, two, or three or more cycles of holding at 25° C. for 24 hours followed by holding at 10° C. for 24 hours.

Other aspects of the invention become apparent from the following description, which is given by way of example only, and with reference to the accompanying Figures.

As used herein the term “and/or” means “and” or “or”, or both.

As used herein “(s)” following a noun means the plural and/or singular forms of the noun.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are considered expressly stated in this application in a similar manner.

The term “comprising” as used in this specification means “consisting at least in part of”. When interpreting statements in this specification which include that term, the features, prefaced by that term in each statement or claim, all need to be present but other features can also be present. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### DESCRIPTION OF THE FIGURES

FIG. 1 is a flow diagram of one aspect of the manufacturing process for producing UHT creams of the invention from cream obtained from milk. Cream produced by separating milk is combined with optionally allowed dairy and/or allowed non-dairy ingredients for adjusting the fat, protein, carbohydrate, cation, anion and, citrate content.

FIG. 2 is a flow diagram of another aspect of the invention for producing the creams using recombining technology. Initially allowed dairy and/or non-dairy ingredients are combined with other allowed dairy and/or non-dairy ingredients. The blend is then combined with suitable concentrated fat sources to produce UHT creams or cream analogues of the invention with desired fat, protein, carbohydrate, cation, anion and, citrate content.

### DETAILED DESCRIPTION OF THE INVENTION

This application provides cream compositions, such as coffee creams, whipping creams and cream analogues comprising a specific combination of ingredients resulting in a temperature robust, stable cream that can withstand temperature fluctuations while maintaining functionality (such as whipping) and avoiding defects.

Furthermore, the invention provides creams that retain the natural white colour, natural cream flavour and mouthfeel characteristics, and desired functionality despite temperature cycling, for example during transport or UHT processing. These creams may be made to widely ranging fat contents while containing specific ranges of protein, carbohydrate, and mineral concentrations. Finally, sour or acidic creams of the invention allow UHT processing without destabilisation, such as casein coagulation and without thickening. Preferably, the cream is a UHT cream.

In particular, the compositions have good flavour and mouthfeel at low/no concentrations of protein, through addition of minerals and optionally lactose.

In certain embodiments, the UHT cream is temperature robust and ambient stable between the temperature cycles ranging between 4° C. to about 25° C. Preferably, the UHT cream is stable between the temperature cycles ranging between of 4° C. to about 45° C. In certain embodiments, the UHT cream is temperature and ambient stable after multiple temperature cycles. Preferably, the UHT cream is temperature and ambient stable after 3, 5, or 7 temperature cycles. Even more preferably, the UHT cream is temperature and ambient stable after 10 cycles.

The term “temperature cycling” refers to the sequential changes in cream temperature. Temperature cycling may refer to a change in cream temperature from refrigeration temperatures of about 4 to about 6° C. to ambient temperatures of 18 to about 30° C. The temperature cycling cycle is completed by the subsequent cooling of the cream back to refrigeration temperatures of about 4 to 6° C.

The term “shelf stable” refers to the length of time the UHT cream can be stored at a temperature of 25° C. without detrimental changes in physical and functional properties. Detrimental changes include coagulation, unacceptable increases in viscosity, phase separation, and loss of functionality.

Temperature cycling usually increases product viscosity, which frequently becomes high enough to solidify or gel the cream within the package. Once solidified or gelled the cream does not pour out of the package. Temperature cycling of UHT cream may also create stratified layers (creaming), inhibit whipping ability, greatly increase or reduce whipping times, exude free serum, and depress whipped volume (reduce overrun). These temperature cycling effects limit the ability to maintain desired whipped shapes during storage, e.g. piped rosette shapes become too soft to maintain a sculpted shape or too firm and produce ragged edged shapes. Such changes frequently force the cream to adopt an unacceptable appearance. Therefore, despite possessing microbiological stability, UHT creams and whipping creams must receive continuous refrigeration to preserve quality and functionality.

One example of UHT creams with good ambient temperature cycling stability include creams that remain as pourable liquids or otherwise retain the desired fluid cream properties with essentially no solidification or gelation following exposure to temperature cycling.

Creams of the invention comprise about 7.5 to about 65% fat to conform to relevant legal regulations and customer requirements. Table 1 shows CODEX and some relevant US Food and Drug Administration cream fat requirements. Whipping creams usually contain 30% milk fat to enhance whipping ability and functionality.

TABLE 1
Legally required fat contents for various categories of
cream in CODEX and US FDA Standards of Identity.
Legally Required Fat Content

| | | | | |
|---|---|---|---|---|
| | FDA² | FDA | FDA Light | FDA |
| | Half and | Light | Whipping | Heavy |
| Codex¹ | Half³ | Cream⁴ | Cream⁵ | Cream⁶ |

-%-

| | | | | |
|---|---|---|---|---|
| ≥10 | ≥10 to <18 | ≥18 to <30 | ≥30 to <36 | ≥36 |

¹CODEX Standard for Cream and Prepared Creams (CODEX STAN 288-1976). part 3.3 Composition]
²US Code of Federal Regulations Title 21 Food and Drugs
³21 CFR § 131.180 Half and Half,
⁴21 CFR § 131.155 Light cream,
⁵21 CFR § 131.157 Light whipping cream, and
⁶21 CFR § 131.150 Heavy Cream

In certain embodiments, the UHT cream comprises a fat content of about 25 to about 50% by weight, typically ranging between about 25 to about 35%. In exemplary embodiments of the UHT cream composition, the fat content is about 30 to about 35% by weight. The fat can be derived from any dairy source, for example cream, fresh cream, high fat cream, cream powder, anhydrous milk fat, ghee, buttermilk powder, whole milk powder, high fat milk protein concentrate, β-serum, butter, or whole milk powder. In various embodiments, non-dairy fats are excluded.

Alternatively, or additionally, any appropriate fat or oil suitable for food use may be used. Suitable alternative fat sources include the group of refined and/or hydrogenated vegetable fat sources consisting of palm, palm kernel, coconut, soybean, rapeseed, cottonseed, sunflower seed, corn, safflower seed, rice bran oil, sesame oil, olive oil, etc. and fractions thereof.

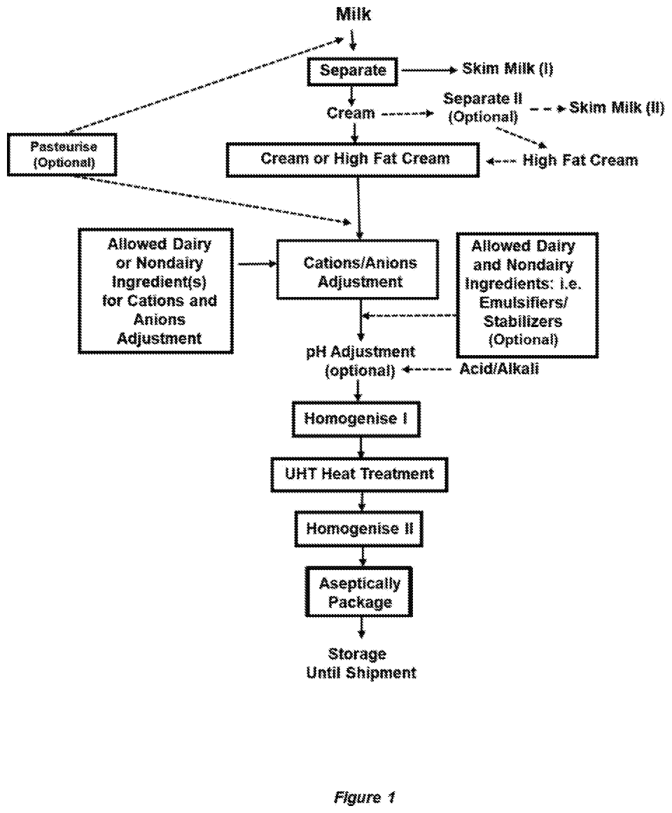

FIG. 1 shows one embodiment for producing UHT creams of the invention. Initially, whole milk is received and separated into cream and skim milk fractions by centrifugal separators, using standard procedures. The initial whole milk or the produced skim milk and cream fractions may be optionally pasteurised. The fat content of such cream typically is about 40 to about 45%, but can be varied as desired. Optionally, cream produced by an initial separation of milk may subsequently receive a second separation by a specialised centrifugal separator to produce “high fat cream” or “plastic cream” with about 70 to 80% milk fat. These processing procedures are well established and deeply embedded in the public domain.

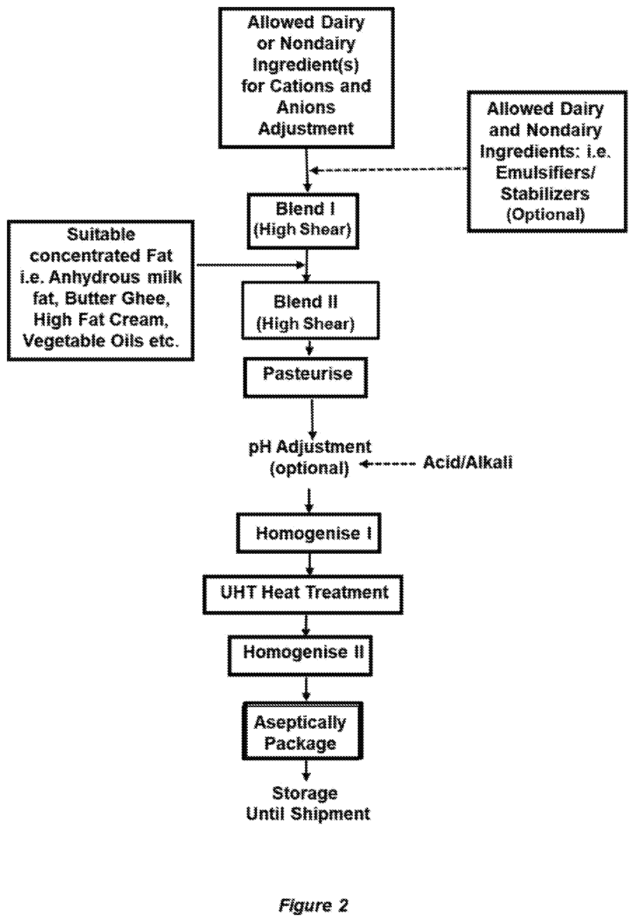

FIG. 2 shows another embodiment for producing UHT creams of the invention. Allowed dairy and/or non-dairy ingredients are combined to adjust the finished anion and cation content. Optionally, suitable dairy and/or non-dairy stabilisers and/or emulsifiers are blended into the initial mixture of anions and cations. Suitable dairy fat ingredients and other dairy and non-dairy ingredients are then blended into the previously prepared blend to produce the desired fat content, as described above. Optionally, the prepared mixture may be pasteurised and receive pH adjustment. Optionally, the mixture is homogenised to produce recombined cream of the desired composition. Preferably the recombined cream is heated to UHT temperatures. Optionally, the heated cream may be homogenised, possibly allowing for two homogenisation treatments. The prepared cream is then packaged, or preferably aseptically packaged and cooled.

The initial milk, cream, high fat cream, recombined cream, cream analogue etc. optionally may be pasteurised or heat treated at any stage of the process. The finished cream preferably will receive a UHT heat treatment immediately before aseptic packaging.

Allowed dairy and non-dairy ingredients then may be selected and blended into the prepared cream as required to produce compositions comprising:
a) about 7.5% to about 65% by weight lipid;
b) about 0% to about 2%, preferably about 0.5% to about 1.2% by weight protein per litre of cream plasma;
c) about 0.01% to about 1.0% by weight of one or more emulsifiers;
d) about 0.05% to about 3%, preferably about 0.05% to about 0.3% by weight of one or more thickeners or stabilisers;
e) about 30 mM to about 120 mM total cations per litre of cream plasma; and
f) about 25 mM to about 120 mM total anions per litre of cream plasma.

As used herein, “cream plasma” is cream minus the milk fat globules. Walstra, P., and R. Jenness. 1984. Dairy Chemistry and Physics. John Wiley & Sons. Pg. 5-6.

In some embodiments, allowed dairy and non-dairy ingredients may be selected and blended into the prepared cream to adjust the specific cation, total divalent cation, total monovalent cation, total cation, total anion, and citrate contents as required to produce the desired compositions.

In various embodiments, the invention provides UHT creams with between 0 to about 2.0% total milk protein. Total milk protein is defined and calculated as follows (Cunniff, P. ed. 1997. § 33.2.11 AOAC Official Method 991.20 Nitrogen (Total) in Milk. Section G. Calculations, Official Methods of Analysis of AOAC International. 16th ed., 3rd Revision. Vol. II. AOAC International. Gaithersburg, Md. (Chapt. 33.2.11):

Total Milk Protein=% Total Milk Nitrogen×6.38

These creams minimise browning to retain initial cream colour, preserve the natural cream flavour and mouthfeel characteristics, and endure fluctuations between refrigeration-to-ambient temperatures by maintaining specific cation and anion concentrations. Preferably, finished creams contain between:
a) about 7.5 to 65% by weight lipid;
b) about 0% to about 2%, preferably about 0.5% to about 1.2% by weight protein per litre of cream plasma;
c) about 0.01% to about 1.0% by weight of one or more emulsifiers;
d) about 0.05% to about 3%, preferably about 0.05% to about 0.3% by weight of one or more thickeners or stabilisers;
e) about 5 to about 60 mM total divalent cations per litre of cream plasma;
f) about 25 to about 60 mM total monovalent cations per litre of cream plasma; and
g) about 25 to about 120 mM total anions per litre of cream plasma, including about 5 to about 15 mM citrate per litre of cream plasma.

Suitable dairy ingredients for providing the total protein, carbohydrate, specified cations, selected anions, and citrate are as described herein. The cation and anion content of these ingredients may be altered by ion exchange or membrane filtration.

In certain embodiments, the UHT cream comprises a total protein content of 0 to 2% by weight, for example 0.0001 to 2% or between 0.15 to 0.5%. For example, in certain exemplary embodiments of the UHT cream composition, the protein content is between 0.1 to 1.2%. Preferably, the composition comprises one or more mammalian milk proteins, more preferably one or more bovine milk proteins, wherein the protein comprises or comprises a source of protein selected from the group consisting of milk, skim milk, cream, whole milk, acid whey, sweet whey, whole milk powder (WMP), skim milk powder, acid whey powder, sweet whey powder, buttermilk powder, sodium caseinate, calcium caseinate, potassium caseinate, casein hydrolysates, whey protein concentrate, whey protein isolate (WPI), whey protein hydrolysates, milk protein isolate (MPI), milk protein concentrate (MPC), and modified MPC derivatives or micellar casein. In various embodiments, non-dairy proteins are excluded. Alternatively, or additionally, non-dairy protein sources may be selected from a group of non-dairy sources consisting of soy, egg, and/or pea protein, or any combination of two or more thereof.

Specific dairy sources of identified cations, anions, and citrate may include permeate produced by membrane filtration of milk or whey. Membrane filtration includes microfiltration (MF), ultrafiltration (UF), and nanofiltration (NF). Permeate may receive further membrane filtration, ion exchange, and/or electrodialysis processing to fractionate or concentrate the protein, carbohydrate, cations, anions, and/or citrate. Suitable fraction technologies include nanofiltration and ion exchange. In some embodiments, the permeate and/or permeate fractions could be at natural pH or from acidic sources. The permeate and/or permeate fractions may be further concentrated and/or dried, for example the dairy source may be permeate powder. Dried or powdered permeate may be reconstituted before use. Lactose may also be removed from permeate to provide another suitable source of cations and anions, such as phosphate, chloride and citrate. Suitable non-dairy mineral sources may include prepared simulated milk ultrafiltrate (SMUF) preparations, as described by Jenness and Koops (1962. Preparation and properties of a salt solution which simulates milk ultrafiltrate. Netherlands Milk and Dairy J. 16:153-164).

Suitable protein, carbohydrate, and minerals may be combined directly. Non-dairy sources of the identified cations and anions may be combined to prepare SMUF or similar preparations. Suitable minerals also may be added as inorganic salts including: sodium, potassium, calcium, and magnesium salts of chloride and/or phosphate. Alternatively, suitable minerals may be added as organic salts, including: calcium, magnesium, sodium, and/or potassium salts of lactate, citrate, lactobionic acid, etc.

Relevant regulations often allow the addition of selected functional ingredients to various creams. CODEX Standard for Cream and Prepared Creams, section 4, Food Additives (CODEX STAN 288-1976) allows the addition of ingredients specifically identified as stabilisers, acidity regulators, thickeners and emulsifiers, and packaging gases and propellants. Relevant US 21 CFR sections allow creams to contain ingredients identified as emulsifiers, stabilisers, and nutritive sweeteners.

Creams of the invention may contain suitable allowed emulsifiers listed in Codex Standard 288-1976 selected from the group consisting of protein, phospholipids from milkfat globule membrane, buttermilk powder, β-serum, β-serum powder (the dried aqueous phase removed from pasteurised dairy cream during the manufacture of AMF), lecithin, mono and diglycerides, distilled monoglycerides, acid esters of mono-diglycerides including lactic, citric, acetic, diacetyltartaric and tartaric, polysorbates (Tweens), sorbitan esters of fatty acids (SPANS), sucrose esters, polyglycerol esters of fatty acids, propylene glycol esters of fatty acids, sodium or calcium stearoyl lactylate, or combinations thereof.

In certain embodiments, the UHT cream comprises an emulsifier content of about 0.05 to about 1.0% by weight, for example between about 0.075 to about 0.5% or from about 0.1 to about 0.3%. Emulsifiers can be selected from dairy and non-dairy emulsifiers, for example but not limited to, protein, phospholipids from milkfat globule membrane, buttermilk powder, β-serum powder, lecithin, mono and diglycerides, polysorbates or Tweens, sucrose esters, lactic acid esters of mono-diglycerides (Lactem), citric acid esters of mono-diglycerides (Citrem), acetic acid esters of mono-diglycerides, polyglycerol esters of fatty acids.

In certain embodiments, the UHT cream comprises a stabiliser content between about 0.05 to about 0.2% by weight, for example between about 0.075 to about 0.175%. In certain exemplary embodiments, the stabiliser content is between about 0.075 to about 0.1%. The creams may contain suitable allowed thickeners and stabilisers wherein the stabiliser is selected from the group consisting of e.g. carrageenan, guar gum, locust bean gum, tara gum, gellan gum, xanthan gum, acacia gum, microcrystalline cellulose (MCC), carboxymethyl cellulose (CMC), cellulose derivatives, propylene glycol alginate, alginate, sodium alginate, pectin, gelatine, or citrus fibre or combinations thereof.

In certain embodiments, the stabiliser in the UHT cream and/or whipping composition is provided by starch or starch derivatives. In certain embodiments, the stabiliser comprises up to 3% by weight of starch or starch derivatives.

In certain embodiments, the UHT cream comprises a buffering or chelating salt content from between 0 to about 0.03% by weight, for example from between about 0.01 to about 0.025%. Buffering salts can be selected from but not limited to, orthophosphates, polyphosphates, and citrates. For example, in certain exemplary embodiments the chelator is sodium or potassium polyphosphate.

In certain embodiments, the UHT cream may comprise food acid. Food acid can be selected from lactic acid, glucono-delta-lactone (GDL), phosphoric acid, malic acid, fumaric acid, tartaric acid or citric acid or any food grade acid. Cream may be acidified by the addition of acidified permeate, or acid whey.

Creams of the invention may be prepared from dairy cream as an initial cream base. Dairy cream is the enriched fat fraction obtained from whole milk, usually by centrifugal separation. Such creams maintain the original, native milk fat globule membrane to emulsify the fat.

Accordingly, in a further aspect, the invention provides a method of preparing a cream composition of the invention, the method comprising
a) separating a first dairy liquid to obtain a cream base;
b) optionally blending a lipid source such as a high fat dairy liquid into the cream base to form a lipid enriched dairy liquid;
c) blending allowed dairy or non-dairy ingredients including minerals, one or more emulsifiers and one or more thickeners or stabilisers into the lipid enriched dairy liquid;
d) homogenising the lipid enriched dairy liquid to form a homogenised lipid enriched dairy liquid including the added allowed dairy or non-dairy ingredients; and
e) heating the homogenised lipid enriched dairy liquid including the added allowed dairy or non-dairy ingredients to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; v) about 30 mM to about 120 mM total cations per litre of cream plasma; and vi) about 25 mM to about 120 mM total anions per litre of cream plasma.

Alternatively, creams of the invention may be produced by blending or “recombining” concentrated milk fat ingredients with liquid or dry milk ingredients and water to produce recombined cream products.

Accordingly, in a further aspect, the invention provides a method of preparing a cream composition of the invention, the method comprising:
a) providing a dairy liquid permeate or a simulated milk ultrafiltrate as a dairy liquid base;
b) blending allowed dairy or non-dairy ingredients including one or more emulsifiers and one or more thickeners or stabilisers into the dairy liquid base;
c) blending a lipid source such as a high fat dairy liquid into the dairy liquid base including the added dairy or non-dairy ingredients to form a lipid enriched dairy liquid;
d) homogenising the lipid enriched dairy liquid to form a homogenised lipid enriched dairy liquid; and
e) heating the homogenised lipid enriched dairy liquid to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; and v) about 30 mM to about 120 mM total cations per litre of cream plasma; and vi) about 25 mM to about 120 mM total anions per litre of cream plasma.

Dairy liquid permeates or a simulated milk ultrafiltrates can be prepared as described above.

In one embodiment, allowed dairy or non-dairy ingredients are blended together to produce the required protein, carbohydrate, cation, anion, and citrate contents for the finished cream. The blend ingredients are mixed together with suitable shear to produce a uniformly dispersed, stable mixture. Suitable allowed ingredients, such as emulsifiers and stabilisers may be incorporated into the previous ingredient blend, also employing sufficient shear. Suitable concentrated fat ingredients are then incorporated into the previously prepared ingredient blend to produce a “recombined cream”. The recombined cream may be processed with both high shear and homogenisation treatments to adequately emulsify the milk fat with the available proteins and/or with emulsifiers. Finally, creams of the invention may be produced by combining any of the previously described approaches, the addition of allowed ingredients, the use of fractionation, and the use of recombined ingredients that produce the desired protein, carbohydrate, and mineral contents. The prepared blend and other allowed ingredients are then processed by typical UHT processing procedures, aseptic packaging, and cooling. Additionally, ingredients allowed as emulsifiers and stabilisers, and the percentages used remain as previously described.

### EXAMPLES

### Example 1

Creams illustrating the invention include a control UHT cream with a typical composition, and two illustrative creams of the invention made with protein, carbohydrate, cation, anion, and citrate. The two illustrative creams of the invention were made with either permeate or SMUF.

A control UHT-like cream was prepared to illustrate temperature cycling issues in traditionally produced UHT creams. Cream processing began by mixing 1.0 g of the non-dairy stabiliser blend (carrageenan, guar and xanthan gums) into 700 g of skim milk, with sufficient shear to dissolve the stabiliser blend. Then, 1.8 g of the non-dairy emulsifier, Tween 60 (polyethylene glycol sorbitan monostearate, Sigma-Aldrich), was uniformly blended into the skim milk/stabiliser mixture. Finally, 300 g of molten anhydrous milk fat (Fonterra Co-operative Group, Ltd., Auckland, New Zealand) was mixed into the skim milk/stabiliser/Tween 60 mixture, and the mixture homogenised with an Ultra-Turrax (Daigger Scientific, Inc., Vernon Hills, Ill.) at a maximum speed for 3 minutes. The cream then received the final heating and homogenising steps described below.

Preparation of a UHT-like cream exemplifying a first cream of the invention began with the collection of fresh permeate produced by the ultrafiltration of pasteurised skim milk. Ultrafiltration processing occurred at room temperature using a 10,000 D molecular weight cut-off membrane. Cream processing continued by completely dissolving 1.25 g of stabiliser blend into 700 g of fresh permeate. Then, 1.8 g of the non-dairy emulsifier, Tween 60 was uniformly blended into the permeate/stabiliser mixture. Finally, 300 g of molten anhydrous milk fat (Fonterra Co-operative Group, Ltd., Auckland, New Zealand) was mixed into the skim milk/stabiliser/Tween 60 mixture, and the mixture homogenised with an Ultra-Turrax, using the maximum speed for 3 minutes. The cream then received the final heating and homogenising steps described below.

Preparation of a UHT-like cream exemplifying another cream of the invention began with the preparation of SMUF by the procedure of Jenness and Koops (1962, as previously referenced). The SMUF was then mixed with enough lactose monohydrate (Fonterra Co-operative Group, Ltd., Auckland, New Zealand) to produce a finished mixture with 5% lactose monohydrate. Cream processing continued by mixing 1.25 g of stabiliser blend into 700 g of fresh SMUF, with sufficient agitation to completely dissolve the stabilisers in SMUF. Then, 1.8 g of the non-dairy emulsifier, Tween 60, was uniformly blended into the skim milk/stabiliser mixture. Finally, 300 g of molten anhydrous milk fat (Fonterra Co-operative Group, Ltd., Auckland, New Zealand) was mixed into the skim milk/stabiliser/Tween 60 mixture, and the mixture homogenised with an Ultra-Turrax operating at maximum speed for 3 minutes. The cream then received the final heating and homogenising steps described below.

Following the initial homogenisations, all cream samples were independently heated to 90° C., held for 10 minutes, and finally homogenised in a GEA Panda homogeniser (GEA New Zealand, Auckland) at 30 bar. The samples were then independently cooled to refrigeration temperatures until further testing.

Table 2 shows the calculated compositions of the three UHT-Like creams and the composition of UHT cream (“Reference UHT cream”) reported in New Zealand.

TABLE 2
Calculated compositions of UHT-Like creams prepared
as examples and typical UHT cream^{b}.

| | | | | Reference |
|---|---|---|---|---|
| | Control | Permeate | SMUF^{a} | UHT Cream^{b} |
| Component | --%-- | | | |
| Moisture | 63.69 | 66.55 | 66.10 | 57.39 |
| Total Solids | 36.31 | 33.40 | 33.90 | 42.61 |
| Fat | 29.96 | 29.88 | 29.89 | 36.73 |
| Total Protein^{c} | 2.42 | 0.20 | 0.00 | 2.20 |
| Lactose | 3.03 | 2.72 | 3.32 | 3.23 |
| Ash | 0.51 | 0.24 | 0.28 | 0.45 |
| Ions^{d} | -- mg/100 g -- | | | |
| Ca | 89.62 | 16.79 | 25.33 | 59.88 |
| Mg | 6.98 | 4.31 | 5.44 | 5.99 |
| Na | 30.29 | 22.04 | 29.59 | 30.94 |
| K | 117.54 | 85.63 | 107.77 | 89.82 |
| TDVCats | 96.60 | 21.10 | 30.77 | 65.87 |
| TMVCats | 147.83 | 107.67 | 137.36 | 120.76 |
| Total Cats | 244.43 | 128.77 | 168.13 | 186.63 |
| PO₄ | 205.47 | 61.17 | 77.12 | 183.46 |
| Cl | 76.79 | 62.38 | 80.28 | 70.05 |
| Citrate | 120.00 | 110.00 | 140.00 | 100.00 |
| Total Anions | 402.26 | 233.55 | 297.40 | 353.51 |
| Ions^{d} | mMole/100 g | | | |
| Ca | 2.24 | 0.42 | 0.63 | 1.49 |
| Mg | 0.29 | 0.18 | 0.22 | 0.26 |
| Na | 1.32 | 0.96 | 1.29 | 1.35 |
| K | 3.01 | 2.19 | 2.76 | 2.30 |
| TDVCats | 2.53 | 0.60 | 0.85 | 1.75 |
| TMVCats | 4.33 | 3.15 | 4.05 | 3.65 |
| Total Cats | 6.86 | 3.75 | 4.90 | 5.40 |
| Cl | 2.17 | 1.76 | 2.26 | 1.98 |
| Citrate | 0.62 | 0.58 | 0.73 | 0.52 |
| PO₄ | 2.16 | 0.64 | 0.81 | 1.93 |
| Total Anions | 4.96 | 2.98 | 3.80 | 4.43 |
| Cations^{d} | mMole/g Total Protein | | | |
| Ca | 0.92 | 2.09 | NA | 0.68 |
| Mg | 0.12 | 0.89 | NA | 0.11 |
| Na | 0.54 | 4.79 | NA | 0.61 |
| K | 1.24 | 10.95 | NA | 1.04 |
| TDVCats | 1.04 | 2.98 | NA | 0.79 |
| TMVCats | 1.79 | 15.74 | NA | 1.66 |
| Total Cats | 2.83 | 18.73 | NA | 2.46 |
| Cl | 0.90 | 8.80 | NA | 0.90 |
| Citrate | 0.26 | 2.88 | NA | 0.24 |
| PO₄ | 2.05 | 3.22 | NA | 0.88 |
| Total Anions | 2.05 | 14.90 | NA | 2.01 |

^{a}SMUF = simulated milk ultrafiltrate produced by the method of Jenness, R. and J. Koops. 1962. Preparation and properties of a salt solutions which simulates milk ultrafiltrate. Netherlands Milk and Dairy J. 16:153-164).
^{b}Visser, F., I. Gray, and M. Williams. 1991. Composition of New Zealand Dairy Products. Chap. 6: Cream and cream products. Copyright NZDB and DSIR ISBB: 0-477-02575-7. (Only provided for compositional comparison.)
^{c}Total Protein = total nitrogen × 6.38.
^{d}Cation abbreviations
Ca = calcium,
Mg = magnesium,
Na = sodium,
K = potassium,
TDVCats = total divalent cations (Ca and Mg)
TMVCats = total monovalent cations (Na and K)
Total Cats = total cations (monovalent and divalent), and
PO₄ = phosphate as calculated from phosphorus.
Cl = chlorine (or chloride ions)
Citrate = Citrate
Total Anions = Sum of Phosphate + Cl + Citrate
NA = not applicable

### Example 2

The control, permeate, and SMUF cream samples of Example 1 were analysed for small strain rheology during temperature cycling, functionality, and iSi gas canister performance.

### Rheology During Temperature Cycling

The stability to temperature cycling was measured using small strain rheology. A MCR301 rheometer (Anton Paar, Germany) with a cup and bob system (CC27, Anton Paar) was used. The rheological properties (in particular the storage modulus, G′) was monitored during temperature cycling. The strain used was 0.05% and the frequency of oscillation was 0.1 Hz. In a typical measurement, the cup was precooled to 5° C., and a sample of cream (˜19 mL) was added to the cup. The bob lowered into position and a thin layer of vegetable oil was placed on the surface of the sample to prevent drying. The experiment was started. The first step monitored the rheological properties at 5° C. for ˜15 minutes. The second step monitored the rheological properties as the temperature was increased from 5° C. to 32.5° C. at a rate of ˜2° C. per minute. The third step monitored the rheological properties at 32.5° C. for ˜15 minutes. The fourth step monitored the rheological properties as the temperature was decreased from 32.5° C. to 5° C. at a rate of ˜2° C. per minute. The fifth step monitored the rheological properties at 5° C. for ˜60 minutes.

### Functionality Analysis

Functionality analysis included the measurement of whipping time, overrun, characteristics of rosettes produced, and chilled rosette stability. Whipping properties were determined by placing 400 mL of cream into a Hobart mixer (Model N-50) with a pre-chilled bowl (5±0.5° C.) and whipping at Speed 3 with a balloon whisk until achieving a firm peak or 5 minutes had elapsed. Firm peak was visually determined by an experienced operator. Typically, firm peak is reached when the whipped cream pulls away from the sides of the bowl and the whipped cream forms a distinctive firm and stable peak on the tip of the inverted whisk. To determine the overrun at firm peak, the weight of the unwhipped cream and whipped cream were independently measured in a 120 mL cup. Overrun was calculated using the following equation

$$\% Overrun = \frac{Unwhipped weight - Whipped weight}{Whipped weight} \times 100$$

Analysis included measurement of the whipping time, overrun, piping the whipped cream into rosettes using a piping bag with a serrated piping nozzle or tip (10 mm diameter), and rosette stability after 24 hour storage at 4° C.

Analysis of the iSi gas canister performance began by placing 400 mL of each individual cream sample into a separate, chilled (4° C.) iSi canister (iSi Vienna, Austria). Each canister was then sealed and charged with nitrous oxide gas. Data collected included the number of shakes required to produce the first acceptable rosette, the number of acceptable rosettes produced, and the amount of waste calculated. Overrun and rosette formation were determined immediately. Rosette stability was initially determined after a holding period of 15 minutes at ambient temperature.

Table 3 shows the specific G′ values for creams prepared for the example at the beginning and at the end of the temperature cycle.

TABLE 3
The G′ of the comparative cream and the cream samples of the
invention made with permeate and SMUF at the beginning and
end of the temperature cycle.

| | Control Cream | Permeate Cream | SMUF Cream |
|---|---|---|---|
| G′ of sample at | 7 | <5 | <5 |
| beginning of | | | |
| temperature | | | |
| cycle (Pa) | | | |
| G′ of sample | 410 | ≈10 | ≈5 |
| at end of | | | |
| temperature | | | |
| cycle (Pa) | | | |
| Observations | Cream was visibly | Cream remained | Cream remained |
| | thick and difficult | liquid and poured | liquid and poured |
| | to remove from | easily from | easily from |
| | rheometer cup | rheometer cup | rheometer cup |
| | following | following | following |
| | temperature cycle. | temperature cycle. | temperature cycle. |

The initial storage modulus, G, of all creams produced for the example was between 7 to <5 Pa and can be considered as nearly identical. However, the G′ of the control sample representing typical cream began increasing as the sample cooled from 32.5 to about 17° C. Ultimately, the G′ of this sample increased to 410 Pa by the end of the temperature cycle, particularly during the later refrigerated storage at ≈5° C. A G′ measurement of 410 Pa indicates the initial stages of gel formation, and cream with very poor temperature cycling stability.

In contrast, the G′ of both the permeate and SMUF creams demonstrating the principles of the invention remained nearly constant throughout and to the end of temperature cycling. Indeed, the G′ of these creams at the end of the temperature cycle were between ≈5 to 10 Pa. Therefore, both cream samples retained the highly desired fluid cream properties without gelling, despite exposure to the temperature cycle.

TABLE 4
The whipping time, overrun, and rosette appearance and chilled
stability of the comparative cream and the cream samples of the
invention made with permeate and SMUF.

| | | | | | Rosette |
|---|---|---|---|---|---|
| | | | | | description |
| | Whipping | | Overrun, | Rosette | after |
| | Time¹ | | % | description | 24 h/4° C. |
| Control | 5 | Min | 140 | Well- | Severe |
| Cream | | | | defined | collapse, |
| | | | | edges, good | loss of edge |
| | | | | height | definition |
| Permeate | 30 | s | 215 | Well- | Severe |
| Cream | | | | defined | collapse, |
| | | | | edges, good | loss of edge |
| | | | | height | definition |
| SMUF | 33 | s | 240 | Well-defined | Significant |

| | | |
|---|---|---|
| Cream | edges, good | collapse; |
| | height | some loss |
| | | in edge |
| | | definition |

¹Min = minutes and s = seconds

The functionality data presented in Table 4 show major differences in whipping times. The typical control cream required 5 minutes to whip. In contrast the creams of the invention made with permeate and SMUF whipped in 30 to 33 seconds. The overrun for the typical control cream was 140%. In contrast the overrun for the creams of the invention made with permeate and SMUF were considerably higher at 215% and 240%, respectively. All the creams produced well-defined rosettes, which showed slumping and collapse after 24 hours at 4° C.

Table 5 provides the iSi gas canister performance for the creams made in this Example.

TABLE 5
iSi gas canister performance of the comparative cream and the
cream samples of the invention made with permeate and SMUF.

| | | | Rosette | |
|---|---|---|---|---|
| | | Rosettes | appearance | |
| | Number of | Produced | after 15 | |
| | Canister | per kg liquid | minutes at | Waste |
| | Shakes | cream | ambient | (%) |
| Control | 50-60 | 38-44 | Soft and | 20 |
| Cream | | | loss in | |
| | | | definition | |
| Permeate | 10 | 56 | Firm with | 6 |
| Cream | | | little change | |
| SMUF | 10 | 56 | Firm with | 4.1-4.3 |
| Cream | | | little change | |

The typical control cream required between 50 to 60 shakes to produce an acceptable rosette with well-defined edges, while both the permeate and SMUF creams of the invention required fewer than 10 shakes. The typical control cream produced the equivalent of 38-44 rosettes per kg liquid cream, whilst the permeate and SMUF cream gave 56 rosettes/kg liquid cream. The rosettes of the typical control cream were soft and after 15 minutes standing at ambient spread and showed a loss in definition. In contrast, the permeate and SMUF creams produced firm rosettes with good definition that were virtually unchanged after standing for 15 minutes at ambient temperature. The waste incurred by the typical control amounted to about 20%, while the calculated cream waste in the permeate and SMUF creams of the invention were about 6 to 4.3% respectively.

### Example 3

To determine the effect of permeate versus skim milk as the continuous phase on the sensory properties of 30% fat recombined creams, four 30% creams with non-dairy emulsifier addition, and varying levels of hydrocolloid/stabiliser were recombined in a food grade lab.

### Formulations and Methods

The continuous or serum phase was either fresh milk permeate, skim milk or skim milk diluted with potable water. The fat phase was anhydrous milkfat (AMF). The preparation methods, including homogenization pressures were similar to those used for the preparation of the creams in Example 1 except the creams were not heated. The samples were chilled to 4° C. after manufacture and used for informal sensory testing within 24 hours of manufacture.

The liquid cream samples were informally tasted in randomised order by 9 untrained panellists who were asked to comment on each of the creams and rate in order of preference, including ties. A second set of two recombined creams containing only one emulsifier, stabiliser at two concentrations, and either skim milk or milk permeate as the continuous phase were tasted next.

### Results and Discussion

The summarised results for the first set of creams are given in Table 6.

TABLE 6
Informal sensory evaluation of skim milk vs. permeate
recombined creams

| Cream | | |
|---|---|---|
| Description* | Code | Comments |
| Permeate; 0.15% | A | Thick, creamy mouthfeel; mouthcoating; |
| stabiliser blend, | | slight to high creamy flavour; slightly |
| | | oxidised |
| Diluted skim milk | B | Slightly less viscous than A; creamy; |
| (75 skim milk: | | slightly watery in mouth → thick |
| 25 water); 0.1% | | mouthfeel; slightly less flavour intensity; |
| stabiliser blend | | slightly oxidised |
| Skim milk; 0.1% | C | Creamy mouthfeel and flavour → thinner |
| stabiliser blend | | and waterier (1 panellist); Less watery than |
| Control | | B and thicker than B; slightly oxidised |
| Permeate; 0.125% | D | Similar to C; stronger dairy flavour and |
| stabiliser blend | | thicker than B (2 panellists); good |
| | | mouthcoating; slightly watery (1 panellist) |
| | | and bland (1 panellist); slight cardboard |
| | | flavour (2 panellists) |

*All creams contained Tween 60 and sucrose ester

TABLE 7
Scores for order of preference (least to most preferred)

| Code | Least Preferred | Most Preferred |
|---|---|---|
| A | 2 | 4 |
| B | 6 | 1 |
| C | 1 | 6 |
| D | 1 | 1 |

The data in Table 6 show that to untrained panellists, all the recombined creams had a creamy flavour and mouthfeel, although viscosity differences were noted and some panellists commented about wateriness in flavour and in-mouth. Oxidation or a slight cardboard flavour was detected by some tasters and this is likely to be a function of the quality of AMF used. When these samples were ranked in terms of preference (Table 7), the least preferred sample was where the skim milk phase had been diluted with water (Sample B). The most preferred cream was Sample C (Control skim milk cream), closely followed by Sample A (permeate cream with a high stabiliser level).

TABLE 8
Informal sensory evaluation of skim milk and permeate creams with
different hydrocolloid concentrations

| Cream Description | Code | Comments |
|---|---|---|
| Skim milk; Tween 60; | E | More viscous than F; mouthcoating; |
| 0.1% stabiliser blend | | creamy; similar taste to F (3 panellists); |
| | | slightly oxidised (1 Panellist); slight |
| | | protein flavour (1 panellist) |
| Permeate; Tween 60; | F | Less viscous than E; creamy; |
| 0.125% stabiliser blend | | mouthcoating; watery (1 panellist) |

Cream samples E and F (Table 3) were both described as being creamy and imparting a mouthcoating, and having a very similar taste. The viscosity of the permeate cream (F) was described as being lower than the skim milk cream (E).

### Conclusions

Untrained panellists could detect a difference in mouthfeel and creamy flavour when the skim milk phase of a recombined cream was diluted with water. Replacement of the skim milk phase with permeate gave creams with similar sensory properties to the control. It is expected that these differences in sensory properties will still be there after UHT treatment.

### Example 4

Creams illustrating the invention include six illustrative creams of the invention made with either permeate or SMUF.

TABLE 9
Ingredients and quantities used (g) for making cream examples

| | Formulation | | | | | |
|---|---|---|---|---|---|---|
| Ingredient | 1 | 2 | 3 | 4 | 5 | 6 |
| AMF | 1201.2 | 600.0 | Blend of | 1201.2 | 600.6 | Blend of |
| SMUF | 0.0 | 0.0 | equal | 1785.9 | 2386.5 | equal |
| Permeate | 1785.9 | 2386.5 | parts of | 0.0 | 0.0 | parts of |
| Tween 60 | 9.0 | 9.0 | formu- | 9.0 | 9.0 | formu- |
| Stabilizer | 3.9 | 3.9 | lations | 3.9 | 3.9 | lations |
| blend | | | 1 and 2 | | | 3 and 4 |

The ingredients for producing illustrative creams containing 40% milk fat in permeate (Formulation 1) or 20% milk fat in permeate (Formulation 2) are given in Table 9. Preparation of Formulation 1 and Formulation 2 of a UHT-like cream exemplifying the creams of the invention was carried out as described for the cream made with permeate in Example 1.

The ingredients for producing illustrative creams containing 40% milk fat in SMUF (Formulation 4) or 20% milk fat in SMUF (Formulation 5) are given in Table 9. Preparation of Formulation 4 and Formulation 5 of a UHT-like cream exemplifying the creams of the invention was carried out as described for the cream made with SMUF in Example 1.

After heating and homogenization, a cream containing 30% milk fat in permeate (Formulation 3) was prepared by mixing 1.25 L of 40% fat cream (Formulation 1) with 1.25 L of 20% fat cream (Formulation 2) with sufficient agitation to give a homogeneous mixture. After heating and homogenization, a cream containing 30% milk fat in SMUF (Formulation 6) was prepared by mixing 1.25 L of 40% fat cream (Formulation 4) with 1.25 L of 20% fat cream (Formulation 5) with sufficient agitation to give a homogeneous mixture. The cream samples were then independently cooled to refrigeration temperatures until further testing.

Table 10 shows the calculated compositions of the six UHT-Like creams. Component definitions are as for Table 2.

TABLE 10
Calculated compositions of UHT-Like creams prepared as examples.

| | Formulation | | | | | |
|---|---|---|---|---|---|---|
| | 1 | 2 | 3 | 4 | 5 | 6 |
| Component | --%-- | | | | | |
| Moisture | 57.10 | 76.00 | 66.55 | 56.70 | 75.48 | 66.10 |
| Total | 42.90 | 24.00 | 33.45 | 43.30 | 24.52 | 33.90 |
| Solids | | | | | | |
| Fat | 39.84 | 19.92 | 29.88 | 39.85 | 19.93 | 29.89 |
| Total | 0.17 | 0.23 | 0.20 | 0.00 | 0.00 | 0.00 |
| Protein^{c} | | | | | | |
| Lactose | 2.33 | 3.11 | 2.72 | 2.85 | 3.79 | 3.32 |
| Ash | 0.21 | 0.27 | 0.24 | 0.24 | 0.32 | 0.28 |
| Ions^{d} | mMole/100 g | | | | | |
| Ca | 0.36 | 0.48 | 0.42 | 0.54 | 0.72 | 0.63 |
| Mg | 0.15 | 0.20 | 0.18 | 0.19 | 0.26 | 0.22 |
| Na | 0.82 | 1.09 | 0.96 | 1.10 | 1.47 | 1.29 |
| K | 1.88 | 2.50 | 2.19 | 2.36 | 3.15 | 2.76 |
| TDVCats | 0.51 | 0.68 | 0.60 | 0.73 | 0.98 | 0.85 |
| TMVCats | 2.70 | 3.60 | 3.15 | 3.47 | 4.62 | 4.05 |
| Total Cats | 3.21 | 4.28 | 3.75 | 4.20 | 5.59 | 4.90 |
| Cl | 1.51 | 2.01 | 1.76 | 1.94 | 2.59 | 2.26 |
| Citrate | 0.49 | 0.65 | 0.58 | 0.63 | 0.83 | 0.73 |
| PO₄ | 0.55 | 0.74 | 0.64 | 0.70 | 0.93 | 0.81 |
| Total | 2.55 | 3.40 | 2.98 | 3.26 | 4.35 | 3.80 |
| Anions | | | | | | |

The permeate and SMUF cream samples were analysed by small strain rheology during temperature cycling, viscosity before and after temperature cycling, fat globule size before and after temperature cycling, functionality before and after temperature cycling, and iSi gas canister performance before and after temperature cycling.

### Rheology During Temperature Cycling:

The stability to temperature cycling was measured as described for Example 2, except that steps 3, 4 and 5 were repeated two further times in sequence to give a total of three temperature cycles from 5° C. to 32.5° C. to 5° C.

### Temperature Cycling for Viscosity, Fat Globule Size, Functionality and iSi Gas Canister Testing

Each cream was subsampled into a sterile container. To prevent microbial growth, 0.02 wt % of sodium azide was added to all subsampled creams from a 20 wt % stock solution. Prior to temperature cycling, all creams were first chilled to 5° C. for at least 24 h. In order to complete 1 cycle from 25 to 10° C., the creams were then transferred to a temperature-controlled storage unit maintained at 25° C. for 24 h followed by storage for 24 h in a separate temperature-controlled storage unit maintained at 10° C. All cycled creams were then transferred back to chilled storage (5° C.) for 24 h before further testing.

In order to complete 5 cycles from 25 to 10° C., the creams were transferred to a temperature-controlled storage unit maintained at 25° C. for 24 h followed by storage for 24 h in a separate temperature-controlled storage unit maintained at 10° C. This cycle from 25° C. to 10° C. was repeated four further times in sequence to give a total of 5 cycles from 25° C. to 10° C. After completing the five cycles, the creams were transferred back to chilled storage (5° C.) for 24 h before further testing.

### Fat Globule Size Measurement

The volume weighted mean diameter (D_{4,3}) of each cream was calculated from the fat globule size distribution measured by laser light scattering using a Mastersizer 2000 (Malvern Instruments). One part cream was gently mixed with nine parts of a dissociating agent known as Walstra's solution and held statically for 10 min before being analysed. Walstra's solution was prepared by mixing 0.375 wt % ethylenediaminetetraacetic acid (EDTA) and 0.125 wt % Tween 20 with deionised water and then adjusting the pH to 10 with 0.1 M sodium hydroxide.

### Viscosity Measurement

The apparent viscosity of the original cream and the temperature cycled cream was determined at 1 s⁻¹ using a 4 cm, 4° C. cone and plate geometry fitted to an AR2000 rheometer (TA instruments). At total of 150 viscosity data points were collected over 10 minutes and the reported viscosity was the average of the final 100 viscosity data points.

### Functionality Analysis

Functionality analysis included the measurement of whipping time, overrun, and characteristics of rosettes produced, and was undertaken as described in Example 2 except that whipping properties were determined using a Kenwood Major Titanium (KM020) whipping at Speed 6. Analysis of the iSi gas canister performance was undertaken as described in Example 2. Overrun and rosette formation were determined immediately.

Table 11 shows the specific G′ values for creams prepared for the examples at the beginning and at the end of each temperature cycle.

TABLE 11
The G′ of the cream samples of the invention made with permeate and
SMUF at the beginning and end of each temperature cycle from 5° C.
to 32.5° C.

| | Formulation | | | | | |
|---|---|---|---|---|---|---|
| | 1 | 2 | 3 | 4 | 5 | 6 |
| G′ of sample at | 38.539 | 6 | 18 | 43 | 5 | 15 |
| beginning of | | | | | | |
| temperature | | | | | | |
| cycle (Pa) | | | | | | |
| G′ of sample at | 40 | 5 | 17 | 34 | 4 | 12 |
| end of | | | | | | |
| temperature | | | | | | |
| cycle 1 (Pa) | | | | | | |
| G′ of sample at | 50 | 5 | 19 | 39 | 4 | 14 |
| end of | | | | | | |
| temperature | | | | | | |
| cycle 2 (Pa) | | | | | | |
| G′ of sample at | 53 | 5 | 20 | 42 | 5 | 15 |
| end of | | | | | | |
| temperature | | | | | | |
| cycle 3 (Pa) | | | | | | |

| | |
|---|---|
| Observations | All cream samples remained liquid and poured |
| | easily from rheometer cup following temperature |
| | cycles. |

For each cream, the G′ did not change markedly between initial measurements and after three temperature cycles. Therefore, all cream samples retained the highly desired fluid cream properties without solidifying, despite exposure to multiple temperature cycles.

Table 12 shows the apparent viscosity for creams prepared for the examples at the beginning and at the end of one and five temperature cycles.

TABLE 12
The viscosities of the cream samples of the invention made
with permeate and SMUF at the beginning and end of the
one and five temperature cycles from 10 to 25° C.

| | Formulation | | | | | |
|---|---|---|---|---|---|---|
| | 1 | 2 | 3 | 4 | 5 | 6 |
| Viscosity of | 1216 | 593 | 872 | 1227 | 638 | 937 |
| sample at | | | | | | |
| beginning of | | | | | | |
| temperature | | | | | | |
| cycle (mPa · s ) | | | | | | |
| Viscosity of | 1228 | 660 | 887 | 1242 | 642 | 802 |
| sample at end | | | | | | |
| of temperature | | | | | | |
| cycle 1 | | | | | | |
| (mPa · s ) | | | | | | |
| Viscosity of | 1378 | 676 | 958 | 980 | 645 | 712 |
| sample at end | | | | | | |
| of temperature | | | | | | |
| cycle 5 | | | | | | |
| (mPa · s ) | | | | | | |

| | |
|---|---|
| Observations | All cream samples remained liquid and |
| | poured easily from container following |
| | temperature cycles. |

For each cream sample, the viscosity did not change markedly between initial measurements and after five temperature cycles, whereas the Control cream from Example 2 had started to solidify after only one temperature cycle (Table 3). Therefore, all inventive cream samples retained the highly desired fluid cream properties without solidifying, despite exposure to multiple temperature cycles.

Table 13 shows the fat globule sizes for creams prepared for the example at the beginning and at the end of one and five temperature cycles.

TABLE 13
The fat globule sizes of the cream samples of the invention
made with permeate and SMUF at the beginning and end
of the one and five temperature cycles from 10 to 25° C.

| Formulation | 1 | 2 | 3 | 4 | 5 | 6 |
|---|---|---|---|---|---|---|
| Fat globule size | 1.97 | 1.44 | 1.75 | 1.98 | 1.63 | 1.86 |
| at beginning of | | | | | | |
| temperature | | | | | | |
| cycle D[4,3] in μm | | | | | | |
| Fat globule size | 1.87 | 1.39 | 1.69 | 2.00 | 1.59 | 1.89 |
| at end of | | | | | | |
| temperature | | | | | | |
| cycle 1 D[4,3] in μm | | | | | | |
| Fat globule size | 1.84 | 1.35 | 1.69 | 1.96 | 1.59 | 1.81 |
| at end of | | | | | | |
| temperature | | | | | | |
| cycle 5 D[4,3] in μm | | | | | | |

For each cream, the fat globule sizes did not change markedly between initial measurements and after three temperature cycles. Therefore, all cream samples retained the highly desired fluid cream properties without solidifying or damaging the fat globules, despite exposure to multiple temperature cycles.

Table 14 shows the whipping properties for creams prepared for the example initially and after one (SC1) and five (SC5) temperature cycles.

TABLE 14
The whipping time, overrun, and rosette appearance
and chilled stability of the cream samples of the
invention made with permeate and SMUF.

| | | Whipping | Overrun, | Rosette |
|---|---|---|---|---|
| Sample | | Time¹ | % | score² |
| Formulation 1 | Initial | 36 s | 230 | 5 |
| | SC1 | 30 s | 200 | 5 |
| | SC5 | 34 s | 200 | 5 |
| Formulation 2 | Initial | 181 s | 250 | 5 |
| | | (3 Min 1 s) | | |
| | SC1 | 43 s | 300 | 5 |
| | SC5 | 51 s | 280 | 5 |
| Formulation 3 | Initial | 39 s | 250 | 5 |
| | SC1 | 24 s | 260 | 5 |
| | SCS | 38 s | 230 | 5 |
| Formulation 4 4 | Initial | 42 s | 240 | 5 |
| | SC1 | 35 s | 200 | 5 |
| | SC5 | 35 | 190 | 5 |
| Formulation 5 | Initial | 270 s | 240 | 4 |
| | | (4 Min 30 s) | | |
| | SC1 | 45 s | 310 | 5 |
| | SC5 | 47 s | 270 | 5 |
| Formulation 6 | Initial | 45 s | 270 | 5 |
| | SC1 | 32 s | 260 | 5 |
| | SC5 | 31 s | 255 | 5 |

1Min = minutes and s = seconds
²Where 5 = firm, well-defined edges and sharp rosette definition and 0 = soft, significant collapse, lack of edge definition

All inventive creams prepared with permeate and SMUF whipped rapidly, produced high overruns and formed well defined rosettes even after temperature cycling. Therefore, all cream samples produced the highly desired whipping properties of a whipping cream despite exposure to multiple temperature cycles.

Table 15 shows the iSi gas canister performance for creams prepared for the example initially and after one (SC1) and five (SC5) temperature cycles.

TABLE 15
iSi gas canister performance of the cream samples of the
invention made with permeate and SMUF.

| | | | Rosettes | | |
|---|---|---|---|---|---|
| | | | Produced | | |
| | | Number of | per kg | | |
| | | Canister | liquid | Rosette | Waste |
| | | Shakes | cream | appearance¹ | (%) |
| Formulation 1 | Initial | 15 | 45 | 4 | 11.5 |
| | SC1 | 10 | 37 | 4.5 | 5.0 |
| | SC5 | 20 | 43 | 4.5 | 9.5 |
| Formulation 2 | Initial | 10 | 43 | 5.0 | 18.3 |
| | SC1 | 10 | 45 | 4.5 | 26.3 |
| | SC5 | 15 | 43 | 5 | 10.9 |
| Formulation 3 | Initial | 10 | 50 | 4.5 | 11.5 |
| | SC1 | 10 | 60 | 4.5 | 5.8 |
| | SC5 | 15 | 47 | 5 | 8.0 |
| Formulation 4 | Initial | 10 | 40 | 5 | 5.0 |
| | SC1 | 10 | 45 | 5 | 6.9 |
| | SC5 | 15 | 47 | 5 | 9.0 |
| Formulation 5 | Initial | 10 | 45 | 4.5 | 30.5 |
| | SC1 | 10 | 62 | 4.5 | 14.6 |
| | SC5 | 15 | 50 | 5 | 10.0 |
| Formulation 6 | Initial | 10 | 50 | 5 | 14.0 |
| | SC1 | 10 | 53 | 4.5 | 8.1 |
| | SC5 | 15 | 52 | 4.5 | 7.2 |

¹Rosette score of 4.5 to 5 is a well-defined, firm, self-supporting rosette

All inventive permeate and SMUF creams required a low number of shakes to produce acceptable rosettes and produced a large number of well-formed rosettes with low waste. In contrast, the Control cream from Example 2 required a high number of shakes (50-60) and had about 20% wastage (Table 5). Therefore, all these inventive cream samples produced the highly desired gas canister performance of a whipping cream despite exposure to multiple temperature cycles.

### Example 5

Creams illustrating the invention include two illustrative creams of the invention made with modified SMUF formulations with either modified mineral compositions or using sucrose instead of lactose as the sweetener.

TABLE 16
Ingredients and quantities used (g) to produce
illustrative creams.

| Formulation | 7 | 8 |
|---|---|---|
| Ingredient | 30% fat cream in | 30% fat cream in |
| | SMUF, with | SMUF, with no |
| | sucrose | Ca/Mg |
| AMF | 900.9 | 900.9 |
| Modified SMUF | 2085.6 | 2085.6 |
| Tween 60 | 0 | 9 |
| Tween 60/sucrose | 9 | 0 |
| ester blend | | |
| Stabilizer blend | 4.5 | 3.9 |

The ingredients for producing illustrative creams containing 30% milk fat in modified SMUF are given in Table 16. Preparation of Formulation 7 of a UHT-like cream with a different sweetener exemplifying the creams of the invention was carried out as described for the cream made with SMUF in Example 1, except that the SMUF was mixed with enough sucrose to produce a finished mixture with 0.8% sucrose. This level of sucrose is approximately equivalent in sweetness to 5% lactose. Cream processing continued as described in Example 1.

Preparation of Formulation 8 of a UHT-like cream with a different SMUF mineral composition exemplifying the creams of the invention was carried out as described for Formulation 7 above, except that the SMUF formulation was first modified to remove all calcium and magnesium from the SMUF. The modified SMUF was then mixed with enough lactose monohydrate to produce a finished mixture with 5% lactose monohydrate. Cream processing continued as described in Example 1.

Table 17 shows the calculated compositions of the four UHT-Like cream samples. Component definitions are as for Table 2.

TABLE 17
Calculated compositions of UHT-Like creams
prepared as examples.

| | Formulation 7 | Formulation 8 |
|---|---|---|
| Component | —%— | |
| Moisture | 68.89 | 66.10 |
| Total Solids | 33.90 | 33.90 |
| Fat | 29.89 | 29.89 |
| Total Protein^{c} | 0.00 | 0.00 |
| Lactose | 0.00 | 3.32 |
| Sucrose | 0.5312 | 0.00 |
| Ash | 0.28 | 0.22 |
| Ions^{d} | mMole/100 g | |
| Ca | 0.63 | 0.00 |
| Mg | 0.22 | 0.00 |
| Na | 1.29 | 1.40 |
| K | 2.76 | 3.01 |
| TDVCats | 0.85 | 0.00 |
| TMVCats | 4.05 | 4.41 |
| Total Cats | 4.90 | 4.41 |
| Cl | 2.26 | 2.08 |
| Citrate | 0.73 | 0.35 |
| PO₄ | 0.81 | 0.67 |
| Total Anions | 3.80 | 3.10 |

The modified SMUF cream samples were analysed by small strain rheology during temperature cycling, viscosity before and after temperature cycling, fat globule size before and after temperature cycling, functionality before and after temperature cycling, and iSi gas canister performance, as described in Example 4. Rheology during temperature cycling, temperature cycling for viscosity, fat globule size, functionality and iSi gas canister testing, and viscosity measurement, were all undertaken as described in Example 4.

Table 18 shows the specific G′ values for creams prepared for the example at the beginning and then after each temperature cycle on a rheometer.

TABLE 18
The G′ of the cream samples of the invention made
with modified SMUF at the beginning and after one
to three temperature cycles from 5° C. to 32.5° C.

| | Formulation 7 | Formulation 8 |
|---|---|---|
| G′ of sample at beginning | 16.4 | 10.8 |
| of temperature cycle (Pa) | | |
| G′ of sample at end of | 13.2 | 12.0 |
| temperature cycle 1 (Pa) | | |
| G′ of sample at end of | 16.3 | 13.0 |
| temperature cycle 2 (Pa) | | |
| G′ of sample at end of | 19.6 | 14.0 |
| temperature cycle 3 (Pa) | | |

| | |
|---|---|
| Observations | Creams remained liquid and |
| | poured easily from rheometer |
| | cup following temperature cycles. |

For each cream, the G′ did not change markedly between initial measurements and after one and three temperature cycles. The cream samples prepared with modified SMUF remained liquid after multiple temperature cycles, whereas the Control cream from Example 2 had started to solidify after only one temperature cycle (Table 3). Therefore, cream samples prepared with modified SMUF retained the highly desired fluid cream properties without solidifying, despite exposure to the temperature cycle.

Table 19 shows the apparent viscosity for cream examples made with modified SMUF at the beginning and after one and five short temperature cycles.

TABLE 19
The viscosities of the cream samples of the invention made
with modified SMUF at the beginning and after one
and five temperature cycles from 10 to 25° C.

| | Formulation 7 | Formulation 8 |
|---|---|---|
| Viscosity of sample at | 1212 | 852 |
| beginning of | | |
| temperature cycle | | |
| (mPa.s) | | |
| Viscosity of sample at | 1207 | 944 |
| end of temperature | | |
| cycle 1 (mPa.s) | | |
| Viscosity of sample at | 1293 | 805 |
| end of temperature | | |
| cycle 5 (mPa.s) | | |

| | |
|---|---|
| Observations | All cream samples remained liquid |
| | and poured easily from pots |

For each cream sample made with modified SMUF, the viscosity did not change markedly between initial measurements and after five temperature cycles. The samples remained liquid after the temperature cycles. Therefore, the cream samples prepared with modified SMUF retained the highly desired fluid cream properties without solidifying, despite exposure to multiple temperature cycles.

Table 20 shows the fat globule sizes for creams prepared for the example at the beginning and at the end of one and five short temperature cycles.

TABLE 20
The fat globule sizes of the cream samples of
the invention made with modified SMUF.
The fat globule sizes were measured initially
and after one and five temperature
cycles from 10 to 25° C.

| | Formulation 7 | Formulation 8 |
|---|---|---|
| Fat globule size at | 2.10 | 1.70 |
| beginning of temperature | | |
| cycle D [4, 3] in μm | | |
| Fat globule size at end | 2.43 | 1.69 |
| of temperature cycle 1 | | |
| D D [4, 3] in μm | | |
| Fat globule size at end | | |
| of temperature cycle 5 | 2.38 | 1.67 |
| D D [4, 3] in μm | | |

For each cream made with modified SMUF, the fat globule sizes did not change markedly between initial measurements and after three temperature cycles. Therefore, all cream samples made with modified SMUF retained the highly desired fluid cream properties without solidifying or markedly damaging the fat globules, despite exposure to multiple temperature cycles.

Table 21 shows the whipping properties for creams prepared for the example initially and after one (SC1) and five (SC5) temperature cycles.

TABLE 21
The whipping time, overrun, and rosette
appearance and chilled stability of the
cream samples of the invention made
with modified SMUF. The whipping
properties were measured initially and
after 1 and 5 temperature cycles.

| | | Whipping | Overrun, | Rosette |
|---|---|---|---|---|
| Sample | | Time¹ | % | score² |
| Formulation 7 | Initial | 35 s | 210 | 5 |
| | SC1 | 34 s | 215 | 5 |
| | SC5 | 31 s | 180 | 5 |
| Formulation 8 | Initial | 49 s | 260 | 5 |
| | SC1 | 37 s | 260 | 5 |
| | SC5 | 42 s | 250 | 5 |

¹s = seconds
²Rosette score where 5 = firm. well defined edges

All inventive creams prepared with modified SMUF whipped rapidly, produced high overruns and formed well defined rosettes even the samples that had been temperature cycled. Therefore, all cream samples produced the highly desired whipping properties of a whipping cream despite exposure to multiple temperature cycles.

Table 22 shows the iSi gas canister performance for creams prepared for the example initially.

TABLE 22
iSi gas canister performance of the cream samples of the
invention made with modified SMUF. The gas
canister performance was measured
initially and after 1 and 5 temperature cycles.

| | | | Rosettes | | |
|---|---|---|---|---|---|
| | | | Produced | | |
| | | Number of | per kg | | |
| | | Canister | liquid | Rosette | Waste |
| | | Shakes | cream | appearance¹ | (%) |
| Formulation 7 | Initial | 10 | 38 | 5 | 7 |
| | SC1 | 15 | 40 | 5 | 11 |
| | SC5 | 10 | 30 | 5 | 8 |
| Formulation 8 | Initial | 10 | 55 | 5 | 9 |
| | SC1 | 10 | 55 | 5 | 8 |
| | SC5 | 10 | 35 | 5 | 9 |

¹Rosette score of 5 = self-supporting, firm rosette with well-defined edges

All inventive creams made with modified SMUF required a low number of shakes to produce acceptable rosettes and produced many well-formed rosettes with low waste. The inventive modified SMUF creams produced high quality, well defined rosettes. Therefore, all cream samples produced the highly desired gas canister performance of a whipping cream, whereas the control cream from Example 2 had higher wastage (˜20%) and required a greater number of shakes (50-60) (Table 5).

### Example 6

Creams illustrating the invention include four illustrative creams of the invention made with either permeate or SMUF. The pH of the illustrative creams were either at the natural pH of the cream or adjusted to pH 4.6 with lactic acid.

TABLE 23
Ingredients and quantities used (g) to produce illustrative creams.

| Formulation | 9 | 10 | 11 | 12 |
|---|---|---|---|---|
| Ingredients | 30% fat cream in SMUF, | 30% fat cream | 30% fat cream | 30% fat cream |
| | pH ~6.7 | in SMUF, pH | in permeate, | in permeate, |
| | | ~4.6 | pH ~6.7 | pH ~4.6 |
| AMF | 1200 | 1200 | 6100 | 6100 |
| SMUF | 2800 | 2800 | 0 | 0 |
| Permeate | 0 | 0 | 13815 | 13815 |
| Tween | 12 | 12 | 60 | 60 |
| 60/sucrose | | | | |
| ester blend | | | | |
| Stabilizer | 4 | 4 | 25 | 25 |
| blend | | | | |
| Lactic acid | 0 | to pH 4.6 after | 0 | to pH 4.6 |
| (25% | | heating | | before |
| solution) | | | | heating |

The ingredients for producing illustrative creams containing 30% milk fat in SMUF (Formulations 9 and 10) are given in Table 23. Preparation of a UHT-like cream exemplifying the creams of the invention was carried out as described for the cream made with SMUF in Example 1, except that after the final heating and homogenising steps described below, the cream for Formulation 10 was adjusted to pH 4.6 with 25% lactic acid after heating.

The ingredients for producing illustrative creams containing 30% milk fat in permeate (Formulations 11 and 12) are given in Table 23. Preparation of a UHT cream exemplifying the creams of the invention was carried out as described for the cream made with permeate in Example 1, except that after the initial homogenisation, the cream for formulation 12 was adjusted to pH 4.6 with 25% lactic acid. The cream then received the final UHT heating and homogenising steps described below.

Creams in formulations 9 and 10 were initially homogenised, then independently heated to 90° C., held for 10 minutes, and finally homogenised in a GEA Panda homogeniser (GEA New Zealand, Auckland). Creams in formulations 11 and formulation 12 were initially homogenised, then heated by UHT at 142° C. for 4 s and finally homogenised and aseptically packaged. The independent cream samples were then cooled to refrigeration temperatures until further testing.

Table 24 shows the calculated compositions of the four UHT-Like cream samples. Component definitions are as for Table 2.

TABLE 24
Calculated compositions of UHT-Like creams prepared as examples.

| | Form- | Form- | Form- | Form- |
|---|---|---|---|---|
| | ulation 9 | ulation 10 | ulation 11 | ulation 12 |
| Component | —%— | % | % | % |
| Moisture | 66.10 | 66.10 | 66.55 | 66.55 |
| Total Solids | 33.90 | 33.90 | 33.45 | 33.45 |
| Fat | 29.89 | 29.89 | 29.88 | 29.88 |
| Total Protein^{c} | 0.00 | 0.00 | 0.20 | 0.20 |
| Lactose | 3.32 | 3.32 | 2.72 | 2.72 |
| Ash | 0.28 | 0.28 | 0.24 | 0.24 |
| Ions^{d} | mMole/100 g | | | |
| Ca | 0.63 | 0.63 | 0.42 | 0.42 |
| Mg | 0.22 | 0.22 | 0.18 | 0.18 |
| Na | 1.29 | 1.29 | 0.96 | 0.96 |
| K | 2.76 | 2.76 | 2.19 | 2.19 |
| TDVCats | 0.85 | 0.86 | 0.60 | 0.60 |
| TMVCats | 4.05 | 4.04 | 3.15 | 3.15 |
| Total Cats | 4.9 | 4.90 | 3.75 | 3.75 |
| Cl | 2.26 | 2.26 | 1.76 | 1.76 |
| Citrate | 0.73 | 0.73 | 0.58 | 0.57 |
| PO₄ | 0.81 | 0.81 | 0.64 | 0.64 |
| Total Anions | 3.80 | 3.80 | 2.98 | 2.98 |

The permeate and SMUF cream samples were analysed by small strain rheology during temperature cycling as described in Example 2. Fat globule size before and after temperature cycling, functionality before and after temperature cycling, and iSi gas canister performance were analysed as described in Example 4.

### Viscosity Measurement Using a Brookfield Viscometer

The apparent viscosity of the original cream and the temperature cycled cream was determined using a Brookfield viscometer (Brookfield DV1 Prime) coupled with spindle #62. The viscosity was determined at a rotational speed of 30 rpm.

Table 25 shows the specific G′ values for creams prepared for the example at the beginning and at the end of each temperature cycle.

TABLE 25
The G′ of the cream samples of the invention made with permeate
and SMUF at the beginning and end of one temperature
cycle from 5° C. to 32.5° C.

| | Form- | Form- | Form- | Form- |
|---|---|---|---|---|
| | ulation 9: | ulation 10: | ulation 11: | ulation 12: |
| G′ of sample | 2.88 | 4.08 | 7.89 | 8.97 |
| at beginning | | | | |
| of | | | | |
| temperature | | | | |
| cycle (Pa) | | | | |
| G′ of sample | 3.88 | 9.38 | 11.70 | 7.29 |
| at end of | | | | |
| temperature | | | | |
| cycle 1 (Pa) | | | | |

| | |
|---|---|
| Observations | Cream remained liquid and poured |
| | easily from rheometer cup |
| | following the temperature cycle |

For each cream, the G′ did not change markedly between initial measurements and after one temperature cycle. The cream samples remained liquid after the temperature cycle. Therefore, cream samples both at natural pH and acidic pH retained the highly desired fluid cream properties without solidifying, despite exposure to the temperature cycle. In contrast, the Control cream in Example 2 had started to solidify after one cycle and had poor temperature cycling stability (Table 3).

Table 26 shows the apparent viscosity for formulations 11 and 12 creams made with permeate at the beginning and at the end of one and five short temperature cycles.

TABLE 26
The viscosities of the cream samples of the invention made
with permeate at the beginning and end of the one and
five temperature cycles from 10 to 25° C.

| | Formulation 11 | Formulation 12 |
|---|---|---|
| Viscosity of | 138 | 127 |
| sample at | | |
| beginning of | | |
| temperature | | |
| cycle (mPa.s) | | |
| Viscosity of | 143 | 139 |
| sample at end | | |
| of temperature | | |
| SC1 (mPa.s) | | |
| Viscosity of | 159 | 166 |
| sample at end | | |
| of SC5 | | |
| (mPa.s) | | |

| | |
|---|---|
| Observations | All cream samples remained liquid |
| | and poured easily from pots |

For each cream sample made with permeate, the viscosity did not change markedly between initial measurements and after five temperature cycles. The samples remained liquid after the temperature cycles. Therefore, the cream samples both at natural pH and at acidic pH retained the highly desired fluid cream properties without solidifying, despite exposure to multiple temperature cycles.

Table 27 shows the fat globule sizes for creams prepared for the example at the beginning and at the end of one and five temperature cycles.

TABLE 27
The fat globule sizes of the cream samples
of the invention made with permeate
and SMUF. The permeate samples had
fat globule sizes measured initially and
after one and five temperature cycles from
10 to 25° C.

| | Form- | Form- | Form- | Form- |
|---|---|---|---|---|
| | ulation | ulation | ulation | ulation |
| | 9 | 10 | 11 | 12 |
| Fat globule size at | 2.80 | 2.08 | 2.53 | 2.97 |
| beginning of | | | | |
| temperature cycle | | | | |
| D [4, 3] in μm | | | | |
| Fat globule size at end | | | | |
| of temperature cycle 1 | ND | ND | 3.45 | 3.84 |
| D [4, 3] in μm | | | | |
| Fat globule size at end | | | | |
| of temperature | ND | ND | 3.41 | 3.38 |
| cycle 5 | | | | |
| D [4, 3] in μm | | | | |
| ND = not determined | | | | |

For each cream made with permeate, the fat globule sizes did not change markedly between initial measurements and after five temperature cycles. Therefore, all cream samples retained the highly desired fluid cream properties without solidifying or markedly damaging the fat globules, despite exposure to multiple temperature cycles.

Table 28 shows the whipping properties for creams prepared for the example initially and after one (SC1) and five (SC5) temperature cycles. Samples made with permeate had whipping properties measured initially and after 1 and 5 temperature cycles.

TABLE 28
The whipping time, overrun, and rosette appearance and
chilled stability of the cream samples of the invention
made with permeate and SMUF.

| | | Whipping | Overrun, | Rosette |
|---|---|---|---|---|
| Sample | | Time¹ | % | score² |
| Formulation 9 | Initial | 37 s | 200 | 4 |
| Formulation 10 | Initial | 34 s | 180 | 4 |
| Formulation 11 | Initial | 37 s | 260 | 5 |
| | SC1 | 32 s | 270 | 5 |
| | SC5 | 24 | 250 | 5 |
| Formulation 12 | Initial | 33 s | 260 | 5 |
| | SC1 | 29 s | 260 | 5 |
| | SC5 | 27 s | 230 | 5 |

¹s = seconds
²Rosette score where 5 = firm. well defined edges and 4 firm, edges jagged or not as well defined

All inventive creams prepared with permeate and SMUF whipped rapidly, produced high overruns and formed well defined rosettes even the samples at pH 4.6 and the samples that had been temperature cycled. Therefore, all cream samples produced the highly desired whipping properties of a whipping cream despite exposure to multiple temperature cycles.

Table 29 shows the iSi gas canister performance for creams prepared for the example initially.

TABLE 29
iSi gas canister performance of the cream samples of the
invention made with permeate and SMUF.

| | | | Rosettes | | |
|---|---|---|---|---|---|
| | | | Produced | | |
| | | Number of | per kg | | |
| | | Canister | liquid | Rosette | Waste |
| | | Shakes | cream | appearance | (%) |
| Formulation 9: | Initial | ≤1.0 | 55 | 5 | 7 |
| Formulation 10: | Initial | ≤1.0 | 58 | 5 | ND |
| Formulation 11: | Initial | 15 | 38 | 5 | 11.3 |
| Formulation 12: | Initial | 15 | 40 | 5 | 12.9 |

ND = not determined
Rosette score of 5 = well defined edges, minimal slumping at time zero.

All inventive permeate and SMUF creams required a low number of shakes to produce acceptable rosettes, produced many well-formed rosettes, and minimised waste. The inventive permeate and SMUF creams produced good, well defined rosettes, whereas the Control cream from Example 2 required a large number of shakes (50-60) and had a typical wastage of about 20% (Table 5). Therefore, the permeate and SMUF cream samples produced the highly desired gas canister performance of a whipping cream.

### Example 7

Creams illustrating the invention include two illustrative creams of the invention, with comparison to a typical commercial UHT whipping cream. The two illustrative creams of the invention were made with permeate or permeate with added skim milk powder.

TABLE 30
Ingredients and quantities used (g) to produce illustrative creams.

| | Formulation | |
|---|---|---|
| | | 14 |
| | | 30% fat cream in |
| | 13 | permeate/skim milk |
| Ingredients | 30% fat cream in permeate | powder (1.2% protein) |
| AMF | 900.9 | 900 |
| Skim milk powder | 0 | 110.1 |
| Permeate | 2085.6 | 1977.3 |
| Tween 60/sucrose | 9 | 9 |
| ester blend | | |
| Stabilizer blend | 4.5 | 3.6 |

The ingredients for producing illustrative creams containing 30% milk fat in permeate (Formulation 13) are given in Table 30. A UHT cream exemplifying the creams of the invention was prepared as described for the cream made with permeate in Example 1.

The ingredients for producing illustrative creams containing 30% milk fat in permeate/skim milk powder (Formulation 14) are given in Table 30. A UHT cream exemplifying the creams of the invention was prepared as described for the cream of Formulation 13, except that the skim milk powder was completely dissolved into the fresh permeate prior to addition of the stabiliser blend.

Table 31 shows the calculated compositions of the two UHT-Like cream samples. Component definitions are as for Table 2.

TABLE 31
Calculated compositions of UHT-Like creams prepared as examples.

| | Formulation | |
|---|---|---|
| | 13 | 14 |
| Component | --%-- | |
| Moisture | 66.55 | 64.02 |
| Total Solids | 33.45 | 35.98 |
| Fat | 29.88 | 29.88 |
| Total Protein^{c} | 0.20 | 1.21 |
| Lactose | 2.72 | 3.89 |
| Ash | 0.24 | 0.44 |
| Ions^{d} | mMole/100 g cream | |
| Ca | 0.42 | 1.22 |
| Mg | 0.18 | 0.24 |
| Na | 0.96 | 1.20 |
| K | 2.19 | 2.74 |
| TDVCats | 0.60 | 1.47 |
| TMVCats | 3.15 | 3.94 |
| Total Cats | 3.75 | 5.41 |
| Cl | 1.76 | 2.10 |
| Citrate | 0.58 | 0.65 |
| PO₄ | 0.64 | 1.34 |
| Total Anions | 2.98 | 4.09 |

The illustrative cream samples and a typical commercial UHT whipping cream were analysed by small strain rheology during temperature cycling, viscosity before and after temperature cycling, fat globule size before and after temperature cycling, functionality before and after temperature cycling, and iSi gas canister performance, as described in Example 4.

Table 32 shows the specific G′ values for creams prepared for the illustrative examples and a typical commercial UHT whipping cream at the beginning and after each temperature cycle.

TABLE 32
The G′ of the illustrative cream samples of the invention made with
permeate (formulation 13) or permeate/skim milk powder (formulation 14)
and a typical commercial UHT whipping cream at the beginning and after
each temperature cycle from 5° C. to 32.5° C.

| | | | Commercial UHT |
|---|---|---|---|
| | Formulation 13 | Formulation 14 | whipping cream |
| G′ of sample | 11 | 8 | 27 |
| at beginning | | | |
| of temperature | | | |
| cycle (Pa) | | | |
| G′ of sample | 12 | 15 | 122,000 |
| at end of | | | |
| temperature | | | |
| cycle 1 (Pa) | | | |
| G′ of sample | 14 | 19 | 3,340 |
| at end of | | | |
| temperature | | | |
| cycle 2 (Pa) | | | |
| G′ of sample | 15 | 21 | 6,320 |
| at end of | | | |
| temperature | | | |
| cycle 3 (Pa) | | | |

| | | |
|---|---|---|
| Observations | Cream remained liquid and poured easily | Solid, difficult to |
| | from rheometer cup following the | remove from |
| | temperature cycles | rheometer cup |
| | | following the third |
| | | temperature cycle. |

For illustrative cream samples of the invention made with permeate (Formulation 13) or permeate/skim milk powder (formulation 14) the G′ did not change markedly between initial measurements and after one, two or three temperature cycles. The illustrative cream samples remained liquid after the temperature cycles. Therefore, the illustrative creams retained the highly desired fluid cream properties without solidifying, despite exposure to the temperature cycles. For the commercial UHT whipping cream, the G′ increased markedly after the first temperature cycle and remained high after subsequent temperature cycles. The commercial UHT cream sample solidified after one cycle and remained solid after subsequent cycles, indicating poor temperature cycling stability.

Table 33 shows the apparent viscosity for the illustrative cream examples and the typical commercial UHT whipping cream at the beginning and after one (SC1) and five (SC5) short temperature cycles.

TABLE 33
The viscosities of the illustrative cream samples of the invention made
with permeate (Formulation 13) or permeate/skim milk powder (Formulation 14)
and a typical commercial UHT whipping cream at the beginning and after one
or five short temperature cycles from 10 to 25° C.

| | | | Commercial UHT |
|---|---|---|---|
| | Formulation 13 | Formulation 14 | whipping cream |
| Viscosity of | 1221 | 1177 | 636 |
| sample at | | | |
| beginning of | | | |
| temperature | | | |
| cycle (mPa · s) | | | |
| Viscosity of | 1197 | 1230 | 1410 |
| sample at end | | | |
| of temperature | | | |
| SC1 (mPa · s) | | | |
| Viscosity of | 1238 | 1115 | Solid |
| sample at end of | | | |
| SC5 (mPa · s) | | | |

| | | |
|---|---|---|
| Observations | All cream samples remained liquid and | Thickened after one |
| | poured easily from pots | cycle, solid after five |
| | | cycles |

For the illustrative cream samples of the invention made with permeate (Formulation 13) or permeate/skim milk powder (formulation 14), the viscosity did not change markedly between initial measurements and after one and five temperature cycles. The illustrative cream samples remained liquid after the temperature cycles. Therefore, the illustrative cream samples retained the highly desired fluid cream properties without solidifying, despite exposure to the temperature cycles. The commercial UHT whipping cream thickened after one temperature cycle and was solid after five temperature cycles.

Table 34 shows the fat globule sizes for the illustrative cream examples and the typical commercial UHT whipping cream at the beginning and after of one and five short temperature cycles.

TABLE 34
The fat globule sizes of the illustrative cream samples of the invention
made with permeate (Formulation 13) or permeate/skim milk powder
(Formulation 14) and a typical commercial UHT whipping cream at
the beginning and after one or five short temperature cycles from
10 to 25° C.

| | | | Commercial UHT |
|---|---|---|---|
| | Formulation 13 | Formulation 14 | whipping cream |
| Fat globule | 1.76 | 1.47 | 1.36 |
| size at beginning | | | |
| of temperature | | | |
| cycle D[4, 3] in μm | | | |
| Fat globule size | 1.83 | 1.50 | 1.39 |
| at end of temperature | | | |
| cycle 1 D[4, 3] in μm | | | |
| Fat globule size at | 1.82 | 1.47 | solid |
| end of temperature | | | |
| cycle 5 D[4, 3] in μm | | | |

For illustrative cream samples of the invention made with permeate (Formulation 13) or permeate/skim milk powder (Formulation 14), the fat globule sizes did not change markedly between initial measurements and after five temperature cycles. Therefore, the illustrative cream samples retained the highly desired fluid cream properties without solidifying or markedly damaging the fat globules, despite exposure to the temperature cycles. The commercial UHT whipping cream had become solid after five temperature cycles.

Table 35 shows the whipping properties for creams prepared for the illustrative examples and a typical commercial UHT whipping cream initially and after one (SC1) and five (SC5) short temperature cycles.

TABLE 35
The whipping time, overrun, rosette appearance and chilled stability
of the illustrative cream samples of the invention made with permeate
(Formulation 13) or permeate/skim milk powder (Formulation 14)
and a typical commercial UHT whipping cream at the beginning and
after one or five short temperature cycles from 10 to 25° C.

| | | | | Rosette |
|---|---|---|---|---|
| Sample | | Whipping Time¹ | Overrun, % | score² |
| Formulation 13 | Initial | 38 s | 225 | 5 |
| | SC1 | 32 s | 230 | 5 |
| | SC5 | 26 s | 205 | 4 |
| Formulation 14 | Initial | 158 s | 225 | 5 |
| | | (2 min 38 s) | | |
| | SC1 | 74 s | 215 | 5 |
| | | (1 min 14 s) | | |
| | SC5 | 67 s | 210 | 5 |
| | | (1 min 7 s) | | |
| Commercial UHT | Initial | 138 s | 130 | 5 |
| whipping cream | | (2 min 18 s) | | |

| | |
|---|---|
| SC1 | not determined |
| SC5 | solid |

¹Min = minutes and s = seconds
²Rosette score where 5 = firm, well defined edges and 4 = firm, edges jagged or not as well defined and 1 = poor rosette, no edge definition, not self-supporting or total slump.

The illustrative cream samples of the invention made with permeate (Formulation 13) or permeate/skim milk powder (Formulation 14) whipped rapidly, produced high overruns and formed well defined rosettes, even after the samples were temperature cycled. Therefore, all cream samples produced the highly desired whipping properties of a whipping cream despite exposure to the temperature cycles. The commercial UHT whipping cream initially produced a good rosette but had a longer whipping time and lower overrun than the inventive creams. The commercial UHT whipping cream was solid after 5 temperature cycles.

Table 36 shows the iSi gas canister performance of creams prepared for the illustrative examples and a typical commercial UHT whipping cream initially and after one (SC1) and five (SC5) short temperature cycles.

TABLE 36
iSi gas canister performance of the illustrative cream samples
of the invention made with permeate (Formulation 13) or permeate/
skim milk powder (Formulation 14) and typical commercial UHT
whipping cream at the beginning and after one or five short
temperature cycles from 10 to 25° C.

| | | | Rosettes | | |
|---|---|---|---|---|---|
| | | Number of | Produced per kg | Rosette | Waste |
| | | Canister Shakes | liquid cream | appearance | (%) |
| Formulation 13 | Initial | 10 | 35 | 5 | 9 |
| | SC1 | 10 | 45 | 5 | 7 |
| | SC5 | 15 | 43 | 5 | 9 |
| Formulation 14 | Initial | 35 | 50 | 3 | 19 |
| | SC1 | 25 | 55 | 4 | 17 |
| | SC5 | 30 | 43 | 5 | 8 |
| Commercial | Initial | 50 | 26 | 5 | 41 |

| | | |
|---|---|---|
| UHT whipping | SC1 | not determined |
| cream | SC5 | Solid |

Rosette score of 5 = well defined edges, minimal slumping at time zero, 1 = poor rosette, no edge definition, not self-supporting or total slump.

The illustrative cream samples of the invention made with permeate (Formulation 13) or permeate/skim milk powder (Formulation 14) required fewer shakes to produce acceptable rosettes and produced more well-formed rosettes with lower waste than the typical commercial UHT whipping cream. The inventive creams made with permeate (Formulation 13) or permeate/skim milk powder (Formulation 14) produced well defined rosettes with good definition even after temperature cycling. Therefore, both inventive cream samples produced the highly desired gas canister performance of a whipping cream. The commercial UHT whipping cream had solidified after five short temperature cycles and could not be tested.

### Example 8

This example evaluates the sensory properties of 30% fat, recombined dairy and non-dairy creams made with permeate, water plus lactose, or modified simulated milk ultrafiltrate (SMUF), versus skim milk as the continuous (serum) phase. The dairy creams were made with anhydrous milkfat, and the non-dairy creams were made with coconut oil, and the creams contained added non-dairy emulsifiers and stabilisers.

### Formulations and Methods

The continuous or serum phase was either fresh skim milk, milk permeate as described in Example 1, modified SMUF (1.58 g/L monopotassium phosphate, 3.35 g/L tripotassium citrate monohyhydrate, 1.79 g/L calcium chloride dihydrate, 0.575 g/L sodium chloride and 0.127 g/L potassium hydroxide) and 8 g/L sucrose to give equivalent sweetness to 5% lactose, or water plus 5% lactose. The fat phase was anhydrous milkfat (AMF) or refined coconut oil. The preparation methods and homogenisation pressures used in Example 1 were employed to prepare the creams, except the creams in this Example were not heated. The samples were chilled to 4° C. after manufacture and used for informal sensory testing within 48 hours of production.

The coded liquid cream samples were tasted informally by 23 untrained panellists. The sample set included a blind duplicate. Panellists were asked to comment on each of the creams and rate an order of preference, which could include ties.

### Results and Discussion

The summarised results for the set of creams are given in Table 37.

TABLE 37
Informal sensory evaluation of skim milk vs. permeate, SMUF, modified SMUF,
lactose plus water creams made with anhydrous milkfat or coconut oil

| Cream Description* | Comments |
|---|---|
| Skim milk + AMF | Creamy mouthfeel and coating, creamy flavour, slightly |
| (Control) | viscous; slight stale, cardboard, oxidised note |
| Permeate + AMF | Creamy mouthfeel, texture and flavour, slightly oxidised |
| (Inventive cream) | and stale |
| Water + lactose + AMF | Watery, thin, low creamy flavour and mouthfeel, bland |
| Modified SMUF + | Creamy mouthfeel and texture, similar to control and |
| sucrose + AMF | (permeate + AMF) sample, slightly oxidised |
| (Inventive cream) | |
| Modified SMUF + | Creamy mouthfeel and texture, similar to control and |
| sucrose + AMF | permeate + AMF sample, slightly oxidised and stale |
| (duplicate) | |
| (Inventive cream) | |
| Permeate + coconut oil | Very white in colour and thick, no dairy fat flavour, |
| (Inventive cream) | bland, good texture in mouth |
| Modified SMUF + | Very white in colour and thick, no dairy fat flavour, |
| sucrose + coconut oil | bland, good texture in mouth, similar to permeate + |
| (Inventive cream) | coconut oil sample |

*All creams contained a stabiliser blend (xanthan, guar and carrageenan) and Tween 60 and sucrose ester, except the skim milk/AMF cream which only contained Tween 60 and the stabiliser blend.

The data in Table 37 show that to untrained panellists, all the recombined dairy fat creams that contained permeate or modified SMUF (inventive creams) had a creamy flavour and mouthfeel. Oxidation or a slight stale, cardboard flavour was detected by many tasters, which was likely due the oxidation of the AMF. In contrast, the recombined dairy cream containing only AMF, lactose plus water was perceived as thin, watery and lacking a creamy flavour and creamy mouthfeel despite the cream containing 30% fat. The coconut oil creams lacked the complex flavour of milkfat but were perceived as creamy in mouth.

When these samples were ranked in terms of preference (Table 38), the least preferred sample was the AMF+lactose+water sample, closely followed by the coconut creams. Although the coconut creams had a creamy mouthfeel, they lacked the milkfat flavour. The most preferred cream was the one containing modified SMUF and where sucrose was used to replace the lactose component.

TABLE 38
Scores for order of preference (least to most preferred)

| | Least | |
|---|---|---|
| | Preferred* | |
| | (Bottom 2 | Most Preferred |
| Cream Description | dislikes) | (Top 2 preferences) |
| Skim milk + AMF | | 8/23 |
| (Control) | | |
| Permeate + AMF | | 10/23 |
| (inventive cream) | | |
| Water + lactose + | 18/23 | |
| AMF | | |
| Modified SMUF + | | 17/23 |
| sucrose + AMF | | |
| (inventive cream) | | |
| Modified SMUF + | | 19/23 |
| sucrose + AMF | | |
| (duplicate) | | |
| (Inventive cream) | | |
| Permeate or | 15/23 | 3/23 |
| (modified SMUF + | | |
| sucrose) + coconut | | |
| oil (Inventive cream) | | |

*Total number of panellists = 23

### Conclusions

Untrained panellists could detect a difference in mouthfeel and creamy flavour when the skim milk (serum) phase of a recombined milkfat cream was replaced with water plus lactose. The addition of minerals to the serum phase via SMUF, modified SMUF containing sucrose, restored much of the creamy flavour and mouthfeel perception. A non-dairy (coconut) cream containing permeate or modified SMUF (sucrose) also had a creamy mouthfeel. These were the inventive creams.

### Example 9

This example evaluates the sensory properties of 30% fat, recombined non-dairy creams of the invention made with either water and lactose, or simulated milk ultrafiltrate (SMUF). The non-dairy creams were made with either coconut oil or a mixture of coconut oil and sunflower oil. Additional recombined creams included a cream made with modified SMUF-AMF, and five illustrative creams of the invention containing non-dairy emulsifiers and stabilisers.

### Formulations and Methods

The continuous or serum phase was either potable water plus 5% lactose, SMUF containing 5% lactose as described in Example 1, or modified SMUF without calcium and magnesium and 5% lactose. The fat phase was refined coconut oil or a blend (30:70) of coconut oil and sunflower oil, or AMF. The preparation methods, including homogenisation pressures were similar to those used in the preparation of the creams in Example 1 except the creams were not heated. The samples were chilled to 4° C. after manufacture and used for informal sensory testing within 24 hours of production. A commercial 35% fat UHT dairy whipping cream served as a control.

The coded liquid cream samples were tasted informally by 12 untrained panellists. A blind duplicate was included in the sample set. Panellists were asked to comment on each of the creams and rate in order of preference, including ties.

### Results and Discussion

The summarised results for the set of creams are given in Table 39.

TABLE 39
Informal sensory evaluation of water/lactose vs. SMUF-containing creams

| Formulation | | |
|---|---|---|
| Number | Cream Description* | Comments |
| 15 | SMUF + lactose + coconut oil | Bit creamy, little flavour, |
| | (Inventive cream) | no dairy flavour, slight |
| | | creamy mouthfeel |
| 16 | Water + lactose + coconut oil | Bland, watery, thin in |
| | | mouth, no mouthcoating |
| 18 | Water + lactose + (30 coconut | Oily, watery, oxidised, |
| | oil: 70 sunflower oil) | thin, unpleasant flavour, |
| | | not creamy |
| 19 | 1:1 blend of Formulation 15 + | Slightly sweet, bland, less |
| | 16 (Inventive cream) | creamy than SMUF- |
| | | containing cream |
| 20 | Commercial 35% fat UHT | Creamy flavour and |
| | cream (Control) | mouthfeel, thick, cooked |
| | | note, sweet |
| 17 | Modified SMUF (Ca and Mg | Creamy mouth coating |
| | free) + lactose + AMF | and flavour but less than |
| | (Inventive cream) | the control, slightly watery |
| | | slightly oxidised, thin |
| 17a | Modified SMUF (Ca and Mg | Creamy mouth coating and |
| | free) + lactose + AMF | flavour but less than the |
| | (Duplicate) (Inventive cream) | control, slightly watery, |
| | | slightly oxidised, thin |

*All experimental creams contained a stabiliser blend (xanthan, guar and carrageenan) and Tween 60 and sucrose ester.

The coconut oil gave the non-dairy creams a very white appearance. Table 39 shows that the untrained panellists judged the non-dairy creams containing only water and lactose in the continuous phase as watery and lacking creamy mouthfeel. The addition of SMUF to the water phase imparted some creamy in-mouth perception to the inventive non-dairy creams. The bland flavour of these non-dairy coconut oil creams can be attributed to this refined fat source that lacked the complex flavour of milkfat. Addition of sunflower oil gave an oxidised flavour to the cream. The very poor quality of this oil source probably caused the panellists to rate this cream the least of the creams (Table 40). The most preferred of the non-dairy creams was the inventive coconut oil cream containing SMUF, as it had a moderate creamy mouthfeel. The removal of Mg and Ca anions from SMUF-containing AMF creams, did not reduce the creamy mouthfeel or flavour.

TABLE 40
Scores for order of preference (least to most preferred)

| | | | Most |
|---|---|---|---|
| | | | Preferred |
| Formulation | | Least | (Top 2 |
| Number | Cream Description | Preferred* | preferences) |
| 15 | SMUF + lactose + coconut oil | | |
| | (Inventive cream) | | |
| 16 | Water + lactose + coconut oil | 1/12 | |
| 18 | Water + lactose + (30 coconut: | 11/12 | |
| | 70 sunflower oil) | | |
| 19 | 1:1 blend of Formulation 15 + | | |
| | 16 (Inventive cream | | |
| 20 | Commercial 35% fat UHT cream | | 11/12 |
| | (Control) | | |
| 17 | Modified SMUF (Ca and | | 10/12 |
| | Mg free) + lactose + AMF | | |
| | (Inventive cream) | | |
| 17a | Modified SMUF (Ca and Mg | | 6/12 |
| | free) + lactose + AMF | | |
| | (Duplicate) (Inventive cream) | | |

*Total number of panellists = 12

### Conclusions

Untrained panellists detected a difference in mouthfeel when the serum or aqueous phase of a recombined non-dairy fat cream contained only water and lactose versus SMUF and lactose. The addition of minerals to the serum phase via SMUF imparted some in-mouth creamy perception to the inventive non-dairy creams. The addition of SMUF without Ca and Mg gave a creamy flavour and mouthfeel to the inventive AMF cream.

### Example 10

Creams of the invention can be made with fat levels of either 7.5% or 50% with either SMUF or milk permeate.

TABLE 41
Ingredients and quantities (g) that can be used to produce creams.

| | Formulation | | | |
|---|---|---|---|---|
| | 21 | 22 | 23 | 24 |
| | 7.5% fat cream | 50% fat cream | 7.5% fat cream | 50% fat cream |
| | in SMUF | in SMUF | in permeate | in permeate |
| AMF | 225 | 750 | 225 | 750 |
| Permeate | 0.00 | 0.00 | 2761.50 | 2237.25 |
| SMUF | 2761.50 | 2237.25 | 0.00 | 0.00 |
| Tween 60 | 9.00 | 9.00 | 9.00 | 9.00 |
| Stabilizer | 4.50 | 3.75 | 4.50 | 3.75 |
| blend | | | | |

The ingredients for producing creams containing 7.5% milk fat in SMUF (Formulation 21) or 50% milk fat in SMUF (Formulation 22) are given in Table 41. Preparation of a UHT-like cream exemplifying the creams of the invention can be carried out as described for the cream made with SMUF in Example 1.

The ingredients for producing creams containing 7.5% milk fat in permeate (Formulation 23) or 50% milk fat in permeate (Formulation 24) are given in Table 41. Preparation of a UHT-like cream exemplifying the creams of the invention can be carried out as described for the cream made with permeate in Example 1. Table 42 shows the expected compositions of the four UHT-Like cream samples. Component definitions are as for Table 2.

TABLE 42
Expected compositions of UHT-Like creams to be prepared as examples.

| | Formulation | | | |
|---|---|---|---|---|
| | 21 | 22 | 23 | 24 |
| Component | --%-- | | | |
| Moisture | 87.22 | 47.31 | 87.82 | 47.64 |
| Total Solids | 12.78 | 52.69 | 12.18 | 52.36 |
| Fat | 7.47 | 49.82 | 7.47 | 49.80 |
| Total Protein^{c} | 0.00 | 0.00 | 0.26 | 0.14 |
| Lactose | 4.38 | 2.38 | 3.59 | 1.95 |
| Ash | 0.37 | 0.20 | 0.32 | 0.17 |
| Ions^{d} | mMole/100 g | | | |
| Ca | 0.83 | 0.45 | 0.55 | 0.30 |
| Mg | 0.30 | 0.16 | 0.23 | 0.13 |
| Na | 1.70 | 0.92 | 1.27 | 0.69 |
| K | 3.64 | 1.97 | 2.89 | 1.57 |
| TDVCats | 1.13 | 0.61 | 0.79 | 0.43 |
| TMVCats | 5.34 | 2.89 | 4.16 | 2.25 |
| Total Cats | 6.46 | 3.51 | 4.94 | 2.68 |
| Cl | 2.99 | 1.62 | 2.32 | 1.26 |
| Citrate | 0.96 | 0.52 | 0.76 | 0.41 |
| PO₄ | 1.07 | 0.58 | 0.85 | 0.46 |
| Total Anions | 5.02 | 2.72 | 3.93 | 2.13 |

The cream samples that can be prepared with 7.5% milk fat in SMUF (Formulation 21), 50% milk fat in SMUF (Formulation 22) 7.5% milk fat in permeate (Formulation 23), or 50% milk fat in permeate (Formulation 24) can be analysed by small strain rheology during temperature cycling, viscosity before and after short temperature cycling, fat globule size before and after short temperature cycling, whipping functionality before and after short temperature cycling, and iSi gas canister performance before and after short temperature cycling, as described for the previous Examples. In addition, the cream samples that can be prepared with 7.5% milk fat in SMUF (Formulation 21) or 7.5% milk fat in permeate (Formulation 23) can be tested for stability, when used in hot beverages, such as coffee or tea, as a whitener/creamer.

### Stability During Temperature Cycling Using Rheology:

For each cream, the G′ as measured by rheology is not expected to change markedly between the initial measurements and after one, two or three temperature cycles. The cream samples are expected to remain liquid after the temperature cycles. Therefore, cream samples prepared with 7.5% milk fat in SMUF (Formulation 21), 50% milk fat in SMUF (Formulation 22) 7.5% milk fat in permeate (Formulation 23), or 50% milk fat in permeate (Formulation 24) are expected to retain the highly desired fluid cream properties without solidifying, despite exposure to multiple temperature cycles.

Viscosity (at 1 s⁻¹) Before and After Short Temperature Cycling:

For each cream, the viscosity is not expected to change markedly between initial measurements and after one or five short temperature cycles. The samples are expected to remain liquid after the temperature cycles. Therefore, cream samples prepared with 7.5% milk fat in SMUF (Formulation 21), 50% milk fat in SMUF (Formulation 22) 7.5% milk fat in permeate (Formulation 23), or 50% milk fat in permeate (Formulation 24) are expected to retain the highly desired fluid cream properties without solidifying, despite exposure to the temperature cycles.

### Fat Globule Sizes Before and After Short Temperature Cycling:

For each cream, the fat globule sizes are not expected to change markedly between initial measurements and after one or five temperature cycles. Therefore, cream samples prepared with 7.5% milk fat in SMUF (Formulation 21), 50% milk fat in SMUF (Formulation 22) 7.5% milk fat in permeate (Formulation 23), or 50% milk fat in permeate (Formulation 24) are expected to retain the highly desired fluid cream properties without solidifying or markedly damaging the fat globules, despite exposure to the temperature cycles.

### Whipping Properties Before and After Short Temperature Cycling

The creams prepared with 7.5% milk fat in SMUF (Formulation 21), or 7.5% milk fat in permeate (Formulation 23) are not expected to have good whipping properties. The samples are not expected to whip to a firm structure and are expected to remain liquid and not be able to be piped to form stable rosettes. The creams prepared with 50% milk fat in SMUF (Formulation 22) or 50% milk fat in permeate (Formulation 24) are expected to whip rapidly, produce high overruns and form well defined rosettes even after being temperature cycled. Therefore, the creams prepared with 50% milk fat in SMUF (Formulation 22) or 50% milk fat in permeate (Formulation 24) are expected to produce the highly desired whipping properties of a whipping cream despite exposure to the temperature cycles.

### iSi Gas Canister Properties Before and After Short Temperature Cycling

The cream samples prepared with 7.5% milk fat in SMUF (Formulation 21), or 7.5% milk fat in permeate (Formulation 23) are not expected to perform in an iSi gas canister. No acceptable rosettes are expected to be formed, and the creams are expected to remain liquid despite shaking in the cannister. The creams prepared with 50% milk fat in SMUF (Formulation 22) or 50% milk fat in permeate (Formulation 24) are expected to require a low number of shakes to produce acceptable rosettes and are expected to produce a large number of well-formed rosettes with low waste. Therefore, the creams prepared with 50% milk fat in SMUF (Formulation 22) or 50% milk fat in permeate (Formulation 24) are expected to produce the highly desired gas canister performance of a whipping cream.

### Application in Hot Coffee/Tea as a Whitener/Creamer

It is expected that the creams prepared with 7.5% milk fat in SMUF (Formulation 21), or 7.5% milk fat in permeate (Formulation 23) will, when added to a hot beverage such as coffee or tea, perform well as a whitener/creamer with good whitening power and a good appearance in the beverage with no defects such as feathering, coagulation or sedimentation. In addition, it is expected that the creams prepared with 7.5% milk fat in SMUF (Formulation 21) or 7.5% milk fat in permeate (Formulation 23) will impart a pleasing creamy mouthfeel and a smooth texture. Therefore, the creams prepared with 7.5% milk fat in SMUF (Formulation 21) or 7.5% milk fat in permeate (Formulation 23) are expected to produce the highly desired hot beverage performance of a coffee/tea/beverage whitener/creamer.

### Sensory

Each cream is expected to impart a creamy mouthfeel, creamy flavour, and good mouthcoating. Formulations 21 to 24 are expected to have flavour typical of a UHT whipping cream at the natural pH.

### Example 11

Creams of the invention can be made with either whey powders or permeate powders.

TABLE 43
Ingredients and quantities (g) that can be used to produce creams.

| | Formulation | | | | |
|---|---|---|---|---|---|
| | | | 27 | 28 | 29 |
| | 25 | 26 | Cream using | Cream using | Cream using |
| | Cream using | Cream using | reconstituted | reconstituted | reconstituted |
| | reconstituted | reconstituted | sweet whey | lactic/cottage | lactic/cottage |
| | milk permeate | sweet whey | permeate | cheese whey | cheese whey |
| | powder | powder | powder | powder | permeate powder |
| AMF | 1200 | 1200 | 1200 | 1200 | 1200 |
| Milk Permeate | 185 | | | | |
| powder | | | | | |
| Sweet whey | | 185 | | | |
| powder | | | | | |
| Sweet whey | | | 185 | | |
| permeate | | | | | |
| powder | | | | | |
| Lactic acid | | | | 185 | |
| whey powder | | | | | |
| Lactic acid | | | | | 185 |
| whey permeate | | | | | |
| powder | | | | | |
| Water | 2597 | 2597 | 2597 | 2597 | 2597 |
| Tween 60 | 12 | 12 | 12 | 12 | 12 |
| Stabilizer | 6 | 6 | 6 | 6 | 6 |
| blend | | | | | |

The ingredients than can be used to produce creams containing 30% milk fat in reconstituted permeate powder (Formulation 25), 30% milk fat in reconstituted sweet whey powder (Formulation 26), 30% milk fat in reconstituted sweet whey permeate powder (Formulation 27), 30% milk fat in reconstituted lactic acid whey powder (Formulation 28), or 30% milk fat in reconstituted lactic acid whey permeate powder (Formulation 29) are given in Table 43.

Preparation of a UHT cream exemplifying the creams of the invention can be carried out as described for the cream made with permeate in Example 1, except that the processing will begin with the reconstitution of the permeate powder (Formulation 25), sweet whey powder (Formulation 26), sweet whey permeate powder (Formulation 27), lactic acid whey powder (Formulation 28), or lactic acid whey permeate powder (Formulation 29) in the water with sufficient agitation to fully disperse the powders.

Table 44 shows the expected compositions of the five UHT-Like cream samples.

TABLE 44
Expected compositions of UHT-Like creams prepared as examples.

| | Formulation | | | | |
|---|---|---|---|---|---|
| | 25 | 26 | 27 | 28 | 29 |
| Component | --%-- | | | | |
| Moisture | 66.55 | 66.19 | 66.51 | 66.14 | 66.46 |
| Total Solids | 33.45 | 33.33 | 33.50 | 33.29 | 33.54 |
| Fat | 29.88 | 29.74 | 29.88 | 29.74 | 29.88 |
| Total Protein^{c} | 0.20 | 0.68 | 0.20 | 0.68 | 0.20 |
| Lactose | 2.72 | 2.54 | 2.55 | 2.37 | 2.384 |
| Lactate | 0.00 | 0.17 | 0.17 | 0.33 | 0.336 |
| Ash | 0.24 | 0.28 | 0.29 | 0.33 | 0.33 |
| Ions^{d} | mMole/100 g | | | | |
| Ca | 0.42 | 0.78 | 0.78 | 1.14 | 1.15 |
| Mg | 0.18 | 0.22 | 0.22 | 0.26 | 0.27 |
| Na | 0.96 | 0.95 | 0.96 | 0.95 | 0.96 |
| K | 2.19 | 2.18 | 2.19 | 2.18 | 2.19 |
| TDVCats | 0.60 | 1.00 | 1.00 | 1.41 | 1.41 |
| TMVCats | 3.15 | 3.13 | 3.15 | 3.13 | 3.15 |
| Total Cats | 3.75 | 4.13 | 4.15 | 4.54 | 4.56 |
| Cl | 1.76 | 1.75 | 1.76 | 1.75 | 1.76 |
| Citrate | 0.58 | 0.57 | 0.57 | 0.57 | 0.57 |
| PO₄ | 0.64 | 0.95 | 0.95 | 1.25 | 1.26 |
| Total Anions | 2.98 | 3.27 | 3.28 | 3.57 | 3.59 |

The creams that can be prepared with reconstituted permeate powders or reconstituted whey powders. These samples can be analysed by small strain rheology during temperature cycling, viscosity before and after short temperature cycling, fat globule size before and after short temperature cycling, whipping functionality before and after short temperature cycling, and iSi gas canister performance before and after short temperature cycling, as described for the previous Examples.

### Stability During Temperature Cycling Using Rheology:

For each cream, the G′ as measured by rheology is not expected to change markedly between the initial measurements and after one, two or three temperature cycles. The cream samples are expected to remain liquid after the temperature cycles. Therefore, cream samples prepared with reconstituted permeate powders or whey powders at the natural pH or acidic pH are expected to retain the highly desired fluid cream properties without solidifying, despite exposure to multiple temperature cycles.

Viscosity (at 1 s⁻¹) Before and After Short Temperature Cycling:

For each cream, the viscosity is not expected to change markedly between initial measurements and after one or five temperature cycles. The samples are expected to remain liquid after the temperature cycles. Therefore, creams prepared with reconstituted permeate powders or whey powders at the natural pH or acidic pH are expected to retain the highly desired fluid cream properties without solidifying, despite exposure to multiple temperature cycles.

### Fat Globule Sizes Before and After Short Temperature Cycling:

For each cream, the fat globule sizes are not expected to change markedly between initial measurements and after one or five temperature cycles. Therefore, creams prepared with reconstituted permeate powders or whey powders at the natural pH or acidic pH are expected to retain the highly desired fluid cream properties without solidifying or markedly damaging the fat globules, despite exposure to multiple temperature cycles.

### Whipping Properties Before and After Short Temperature Cycling

Each cream is expected to whip rapidly, produce high overruns and form well defined rosettes, even the creams at acidic pH and after being temperature cycled. Therefore, the creams prepared with reconstituted permeate powders or whey powders at the natural pH or acidic pH are expected to produce the highly desired whipping properties of a whipping cream, exposure to multiple temperature cycles.

### iSi Gas Cannister Properties Before and After Short Temperature Cycling

Each cream is expected to require fewer shakes to produce acceptable rosettes and is expected to produce more well-formed rosettes with low waste. Therefore, creams prepared with reconstituted permeate powders or whey powders at the natural pH or acidic pH are expected to produce the highly desired gas canister performance of a whipping cream.

### Sensory

Each cream is expected to impart a creamy mouthfeel, creamy flavour, and good mouthcoating. Formulation 25 will have flavour typical of a UHT whipping cream at the natural pH. Creams from formulations 26, 27, 28 and 29 will have some acidic notes and some fermented flavours associated with the cheese and lactic casein origins of the whey powders/permeate powders.

### INDUSTRIAL APPLICATION

The present invention provides cream compositions resistant to temperature cycling/fluctuations/heat-shock having emulsion stability, pourability, functional performance including whipping ability and good flavour and mouthfeel properties. The present invention therefore has a wide range of applications within the food industry. Potential applications include whipping creams for toppings, fillings for cakes, decorating creams, toppings for beverages, and fillings for pastries, éclairs, crème pies, doughnuts, or mousses. In the unwhipped state the creams can be used e.g. as dessert creams, custard creams, in sauces, dressings, ganache, and as coffee creams. Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A cream composition comprising
a) about 7.5% to about 65% by weight lipid;
b) about 0% to about 2% by weight protein;
c) about 0.01% to about 1.0% by weight of one or more emulsifiers;
d) about 0.05% to about 3% by weight of one or more thickeners or stabilisers;
e) about 30 mM to about 120 mM total cations per litre of cream plasma; and
f) about 25 mM to about 120 mM total anions per litre of cream plasma.

2. A composition of claim 1, wherein the composition comprises about 7.5 to about 40% by weight lipid.

3. A composition of claim 1 or claim 2, wherein the lipid comprises cream, high fat cream, reconstituted cream powder, anhydrous milk fat (AMF), refined and/or hydrogenated vegetable fat sources consisting of palm, palm kernel, coconut, soybean, rapeseed, cottonseed, sunflower seed, corn, safflower seed, rice bran oil, sesame oil, olive oil and fractions thereof, or any combination of any two or more thereof.

4. A composition of any one of the preceding claims, wherein the composition comprises 0 to 1.2% by weight protein, preferably 0 to 0.5% protein.

5. A composition of any one of the preceding claims, wherein the protein comprises milk, skim milk, cream, whole milk, acid whey, sweet whey, whole milk powder (WMP), skim milk powder (SMP), buttermilk powder (BMP), acid whey powder, sweet whey powder, caseinate, sodium caseinate, calcium caseinate, whey protein concentrate (WPC), whey protein isolate (WPI), milk protein isolate (MPI), milk protein concentrate (MPC), modified MPC derivatives, micellar casein, soy, egg or pea protein, or any combination of any two or more thereof.

6. A composition of any one of the preceding claims, wherein the one or more emulsifiers are selected from the group consisting of protein, phospholipid from milkfat globule membrane, buttermilk powder, β-serum powder, lecithin, mono and diglycerides, distilled monoglycerides, acid esters of mono-diglycerides including lactic, citric, acetic, diacetyltartaric and tartaric, polysorbates, sorbitan esters of fatty acids, sucrose esters, polyglycerol esters of fatty acids, propylene glycol esters of fatty acids, sodium or calcium stearoyl lactylate, or any combination of any two or more thereof.

7. A composition of any one of the preceding claims, wherein the composition comprises about 0.05% to about 0.3% by weight of one or more emulsifiers.

8. A composition of any one of the preceding claims, wherein the one or more emulsifiers comprise two or more of lecithin, mono and diglycerides, polysorbates, sucrose esters, and propylene glycol esters of fatty acids.

9. A composition of any one of the preceding claims, wherein the composition comprises 0.05% to about 0.3% by weight of one or more thickeners or stabilisers.

10. A composition of any one of the preceding claims, wherein the one or more thickeners or stabilisers are selected from the group consisting of carrageenan, guar gum, locust bean gum, Tara gum, gellan gum, xanthan gum, acacia gum, microcrystalline cellulose (MCC), carboxymethyl cellulose (CMC), cellulose derivatives, propylene glycol alginate, sodium alginate, pectin, gelatin, starch or starch derivatives, or citrus fibre, or any combination of any two or more thereof.

11. A composition of any one of the preceding claims, wherein the one or more thickeners or stabilisers comprise xanthan, carrageenan, and guar gum.

12. A composition of any one of the preceding claims, wherein the composition comprises about 40 to about 60 mM monovalent cations per litre of cream plasma.

13. A composition of any one of the preceding claims, wherein the composition comprises about 5 to about 20 mM divalent cations per litre of cream plasma.

14. A composition of any one of the claims 1 to 12, wherein the composition comprises about 30 to about 60 mM divalent cations per litre of cream plasma.

15. A composition of any one of the preceding claims, wherein the composition comprises about 25 to about 70 mM total anions per litre of cream plasma.

16. A composition of any one of the preceding claims, further comprising about 0.001 to about 6% of a sweetener.

17. A composition of claim 16, wherein the sweetener is a natural or artificial sweetener, preferably wherein the sweetener is lactose.

18. A composition of any one of the preceding claims further comprising a buffering or chelating salt.

19. A composition of any one of the preceding claims further comprising a buffering or chelating salt comprising sodium or potassium polyphosphate.

20. A method of preparing a cream composition, the method comprising
a) separating a first dairy liquid to obtain a cream base;
b) optionally blending a lipid source such as a high fat dairy liquid into the cream base to form a lipid enriched dairy liquid;
c) blending allowed dairy or non-dairy ingredients including minerals, one or more emulsifiers and one or more thickeners or stabilisers into the cream base or the lipid enriched dairy liquid;
d) homogenising the cream base or the lipid enriched dairy liquid to form a homogenised dairy liquid including the added allowed dairy or non-dairy ingredients; and
e) heating the homogenised dairy liquid including the added allowed dairy or non-dairy ingredients to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; v) about 30 mM to about 120 mM total cations per litre of cream plasma; and vi) about 25 mM to about 120 mM total anions per litre of cream plasma.

21. A method of preparing a cream composition, the method comprising
a) providing a dairy liquid permeate or a simulated milk ultrafiltrate as a dairy liquid base;
b) blending allowed dairy or non-dairy ingredients including one or more emulsifiers and one or more thickeners or stabilisers into the dairy liquid base;
c) blending a lipid source such as a high fat dairy liquid into the dairy liquid base including the added dairy or non-dairy ingredients to form a lipid enriched dairy liquid;
d) homogenising the lipid enriched dairy liquid to form a homogenised lipid enriched dairy liquid;
e) heating the homogenised lipid enriched dairy liquid to obtain a cream composition having i) about 7.5% to about 65% by weight lipid; ii) about 0% to about 2% by weight protein per litre of cream plasma; iii) about 0.01% to about 1.0% by weight of one or more emulsifiers; iv) about 0.05% to about 3% by weight of one or more thickeners or stabilisers; and v) about 30 mM to about 120 mM total cations per litre of cream plasma; and vi) about 25 mM to about 120 mM total anions per litre of cream plasma.

22. A method as claimed in claim 20 or claim 21, further comprising a pasteurisation step, preferably prior to step d).

23. A method as claimed in any one of claims 20 to 22, wherein the method comprises an additional step of adjusting the pH of the lipid enriched dairy liquid prior to step d).
